(19) United States
(12) Patent Application Publication
(10) Pub. No.: US 2026/0333449 A1
(43) Pub. Date: Oct. 22, 2026

(54) SIGNAL TRANSMISSION AND RECEPTION METHOD FOR WIRELESS COMMUNICATION, AND DEVICE THEREFOR

(71) Applicant: LG ELECTRONICS INC., Seoul (KR)

(72) Inventors: Youngdae LEE, Seoul (KR); Jaehyung KIM, Seoul (KR); Seungjin AHN, Seoul (KR); Suckchel YANG, Seoul (KR); Seonwook KIM, Seoul (KR); Sunghoon LEE, Seoul (KR)

(73) Assignee: LG ELECTRONICS INC., Seoul (KR)

(21) Appl. No.: 19/116,724

(22) PCT Filed: Sep. 27, 2023
(86) PCT No.: PCT/KR2023/014993

§ 371 Date: Mar. 28, 2025

Related U.S. Application Data
(60) Provisional application No. 63/411,175, filed on Sep. 29, 2022.

(51) Int. Cl. H04W 74/0833; H04W 36/00; H04W 72/21

(52) U.S. Cl. CPC H04W 74/0833; H04W 36/0077; H04W 72/21

(57) ABSTRACT

A terminal according to an embodiment may trigger a random access channel (RACH) procedure with respect to a cell selected on the basis of at least one synchronization signal block (SSB) received from a cell, determine an initial bandwidth within an uplink bandwidth part (UL BWP) of the cell, and cause a physical random access channel (PRACH) or a first message including the PRACH to be transmitted within the initial bandwidth, wherein the initial bandwidth is determined to be one of one or more bandwidths having a first size or less configured with respect to the UL BWP of the cell, on the basis of an index of a SSB having a quality equal to or greater than a predetermined threshold among the one or more SSBs.

### CROSS-REFERENCE TO RELATED APPLICATIONS

This application is the National Stage filing under 35 U.S.C. 371 of International Application No. PCT/KR2023/014993, filed on Sep. 27, 2023, which claims the benefit of U.S. Provisional Application No. 63/411,175 filed on Sep. 29, 2022, the contents of which are all hereby incorporated by reference herein in their entireties.

### TECHNICAL FIELD

The present disclosure relates to wireless communication, and more particularly, to a method of transmitting or receiving an uplink/downlink signal in a wireless communication system and apparatus therefor.

### BACKGROUND

Generally, a wireless communication system is developing to diversely cover a wide range to provide such a communication service as an audio communication service, a data communication service and the like. The wireless communication is a sort of a multiple access system capable of supporting communications with multiple users by sharing available system resources (e.g., bandwidth, transmit power, etc.). For example, the multiple access system may be any of a code division multiple access (CDMA) system, a frequency division multiple access (FDMA) system, a time division multiple access (TDMA) system, an orthogonal frequency division multiple access (OFDMA) system, and a single carrier frequency division multiple access (SC-FDMA) system.

### SUMMARY

The object of the present disclosure is to provide a method of transmitting and receiving signals more accurately and efficiently.

The objects of present disclosure are not limited to what has been particularly described hereinabove, and other objects that the present disclosure could achieve will be more clearly understood from the following detailed description.

According to an aspect, a method of transmitting a signal by a user equipment (UE) in a wireless communication system includes triggering a random access channel (RACH) procedure for a selected cell based on at least one synchronization signal block (SSB), determining an initial bandwidth within an uplink bandwidth part (UL BWP) of the cell, and transmitting a physical random access channel (PRACH) or a first message including the PRACH in the initial bandwidth, wherein the initial bandwidth is determined as one of one or more bandwidths less than or equal to a first size configured for a UL BWP of the cell, based on an index of an SSB having a quality higher than or equal to a specific threshold from among the at least one SSB

The index of the SSB may be an index for an SSB having a highest quality from among SSBs having a quality higher than or equal to the specific threshold from among the at least one SSB.

Based on that there are two or more SSBs having a quality higher than or equal to a specific threshold from among the at least one SSB, the index of the SSB may be an index for one SSB randomly selected from among the two or more SSBs.

The UL BWP of the cell may be configured with a plurality of sub-BWPs having a frequency bandwidth size less than or equal to the first size, and the initial bandwidth may be one sub-BWP determined based on an index of an SSB having a quality higher than or equal to the specific threshold of the at least one SSB from among the plurality of sub-BWPs.

The method may further include receiving a system information block 1 (SIB1) including SSB indices and information about the specific threshold, and each of one or more bandwidths less than or equal to the first size may be pre-mapped with each of the SSB indices.

The method may further include transmitting a message including a physical uplink shared channel (PUSCH) for the RACH procedure in the initial bandwidth.

The RACH procedure may be triggered for initial access, handover, secondary cell (SCell) addition, or SCell activation.

The first size may be 5 MHz.

According to another aspect, a processing device configured to control a user equipment (UE) for transmitting a signal in a wireless communication system includes at least one processor, and at least one memory connected to the at least one processor and storing instructions, the instructions being executed by the at least one processor to cause the UE to trigger a random access channel (RACH) procedure for a selected cell based on at least one synchronization signal block (SSB), determine an initial bandwidth within an uplink bandwidth part (UL BWP) of the cell, and transmit a physical random access channel (PRACH) or a first message including the PRACH in the initial bandwidth, wherein the initial bandwidth is determined as one of one or more bandwidths less than or equal to a first size configured for a UL BWP of the cell, based on an index of an SSB having a quality higher than or equal to a specific threshold from among the at least one SSB.

According to another aspect, a processing device configured to control a user equipment (UE) for transmitting a signal in a wireless communication system includes at least one processor, and at least one memory connected to the at least one processor and storing instructions, the instructions being executed by the at least one processor to cause the UE to trigger a random access channel (RACH) procedure for a selected cell based on at least one synchronization signal block (SSB), determine an initial bandwidth within an uplink bandwidth part (UL BWP) of the cell, and transmit a physical random access channel (PRACH) or a first message including the PRACH in the initial bandwidth, wherein the initial bandwidth is determined as one of one or more bandwidths less than or equal to a first size configured for a UL BWP of the cell, based on an index of an SSB having a quality higher than or equal to a specific threshold from among the at least one SSB.

According to another aspect, a method of receiving a signal by a base station (BS) in a wireless communication system includes transmitting at least one synchronization signal block (SSB), and receiving a physical random access channel (PRACH) or a first message including the PRACH in an initial bandwidth less than or equal to a first size, wherein the initial bandwidth is one bandwidth corresponding to an index of a specific SSB from among a plurality of bandwidths less than or equal to the first size configured for an uplink bandwidth part (UL BWP) related to the BS, and the index of the specific SSB is an index of an SSB having a quality higher than or equal to a specific threshold from among the at least one SSB.

According to another aspect, a BS performing the signal transmission method described above may be provided.

According to an embodiment of the present disclosure, signal transmission and reception may be performed more accurately and efficiently in a wireless communication system.

For example, a user equipment (UE) may explicitly determine/specify an initial frequency band of 5 MHz for transmitting a signal related to a random access channel (RACH) procedure within a UL BWP based on the quality of an SSB.

In addition, even if an initial frequency band is limited to 5 MHz, the initial frequency band may be effectively distributed from among the UEs by determining the initial frequency band based on the quality of the SSB.

The present disclosure is not limited to the technical effects described above, and other technical effects may be inferred from the detailed description.

### BRIEF DESCRIPTION OF THE DRAWINGS

FIG. 1 illustrates physical channels used in a 3rd generation partnership project (3GPP) system as an exemplary wireless communication system, and a general signal transmission method using the same.

FIG. 2 illustrates a radio frame structure.

FIG. 3 illustrates a resource grid of a slot.

FIGS. 4 and 5 are drawings for explaining the structure and transmission method of an SSB (Synchronization Signal Block).

FIG. 6 illustrates a random access procedure.

FIG. 7 illustrates an example of physical channel mapping.

FIG. 8 shows a flow of a signal transmission and reception method according to one embodiment.

FIG. 9 is a diagram for explaining a method of configuring a plurality of sub-BWPs in one BWP.

FIG. 10 is a diagram for explaining a method for a UE to transmit a message related to a RACH procedure to a cell or BS.

FIG. 11 is a diagram for explaining a method for a BS to receive a message related to a RACH procedure from a UE.

FIGS. 12 and 13 illustrate a communication system 1 and wireless devices applied to the present disclosure.

FIG. 14 is a diagram for explaining a DRX (Discontinuous Reception) operation of a UE according to one embodiment.

### DETAILED DESCRIPTION

Embodiments of the present disclosure are applicable to a variety of wireless access technologies such as code division multiple access (CDMA), frequency division multiple access (FDMA), time division multiple access (TDMA), orthogonal frequency division multiple access (OFDMA), and single carrier frequency division multiple access (SC-FDMA). CDMA can be implemented as a radio technology such as Universal Terrestrial Radio Access (UTRA) or CDMA2000. TDMA can be implemented as a radio technology such as Global System for Mobile communications (GSM)/General Packet Radio Service (GPRS)/Enhanced Data Rates for GSM Evolution (EDGE). OFDMA can be implemented as a radio technology such as Institute of Electrical and Electronics Engineers (IEEE) 802.11 (Wireless Fidelity (Wi-Fi)), IEEE 802.16 (Worldwide interoperability for Microwave Access (WiMAX)), IEEE 802.20, and Evolved UTRA (E-UTRA). UTRA is a part of Universal Mobile Telecommunications System (UMTS). 3rd Generation Partnership Project (3GPP) Long Term Evolution (LTE) is part of Evolved UMTS (E-UMTS) using E-UTRA, and LTE-Advanced (A) is an evolved version of 3GPP LTE. 3GPP NR (New Radio or New Radio Access Technology) is an evolved version of 3GPP LTE/LTE-A.

As more and more communication devices require a larger communication capacity, there is a need for mobile broadband communication enhanced over conventional radio access technology (RAT). In addition, massive Machine Type Communications (MTC) capable of providing a variety of services anywhere and anytime by connecting multiple devices and objects is another important issue to be considered for next generation communications. Communication system design considering services/UEs sensitive to reliability and latency is also under discussion. As such, introduction of new radio access technology considering enhanced mobile broadband communication (eMBB), massive MTC, and Ultra-Reliable and Low Latency Communication (URLLC) is being discussed. In the present disclosure, for simplicity, this technology will be referred to as NR (New Radio or New RAT).

For the sake of clarity, 3GPP NR is mainly described, but the technical idea of the present disclosure is not limited thereto. LTE refers to technologies after 3GPP TS 36.xxx Release 8. Specifically, LTE technologies after 3GPP TS 36.xxx Release 10 are referred to as LTE-A, and LTE technologies after 3GPP TS 36.xxx Release 13 are referred to as LTE-A pro. 3GPP NR refers to technologies after TS 38.xxx Release 15. LTE/NR may be referred to as 3GPP systems. In this document, “xxx” represents the detail number of a specification. LTE/NR may be collectively referred to as 3GPP systems.

Details of the background, terminology, abbreviations, etc. used herein may be found in documents published before the present disclosure. For example, the present disclosure may be supported by the following documents:

### 3GPP NR

3GPP TS 38.211: Physical channels and modulation
3GPP TS 38.212: Multiplexing and channel coding
3GPP TS 38.213: Physical layer procedures for control
3GPP TS 38.214: Physical layer procedures for data
3GPP TS 38.215: Physical layer measurements
3GPP TS 38.300: NR and NG-RAN Overall Description
3GPP TS 38.304: User Equipment (UE) procedures in idle mode and in RRC inactive state
3GPP TS 38.321: Medium Access Control (MAC) protocol
3GPP TS 38.322: Radio Link Control (RLC) protocol
3GPP TS 38.323: Packet Data Convergence Protocol (PDCP)
3GPP TS 38.331: Radio Resource Control (RRC) protocol
3GPP TS 37.324: Service Data Adaptation Protocol (SDAP)
3GPP TS 37.340: Multi-connectivity; Overall description
3GPP TS 23.287: Application layer support for V2X services; Functional architecture and information flows
3GPP TS 23.501: System Architecture for the 5G System
3GPP TS 23.502: Procedures for the 5G System
3GPP TS 23.503: Policy and Charging Control Framework for the 5G System; Stage 2
3GPP TS 24.501: Non-Access-Stratum (NAS) protocol for 5G System (5GS); Stage 3
3GPP TS 24.502: Access to the 3GPP 5G Core Network (5GCN) via non-3GPP access networks
3GPP TS 24.526: User Equipment (UE) policies for 5G System (5GS); Stage 3

Technical terms used in this document
UE: User Equipment
SSB: Synchronization Signal Block
MIB: Master Information Block
RMSI: Remaining Minimum System Information
FR1: Frequency Range 1, which refers to the frequency range below 6 GHZ (e.g., 450 MHz to 6000 MHz).
FR2: Frequency Range 2, which refers to the millimeter wave (mmWave) region above 24 GHz (e.g., 24250 MHz to 52600 MHz).
BW: Bandwidth
BWP: Bandwidth Part
RNTI: Radio Network Temporary Identifier
CRC: Cyclic Redundancy Check
SIB: System Information Block
SIB1: SIB1 for NR devices=RMSI (Remaining Minimum System Information). Broadcasts information necessary for cell connection of NR UEs.
CORESET (COntrol REsource SET): Time/frequency resource for NR UE to attempt candidate PDCCH decoding
CORESET #0: CORESET for Type0-PDCCH CSS set for NR devices (Set in MIB)
Type0-PDCCH CSS set: a search space set in which an NR UE monitors a set of PDCCH candidates for a DCI format with CRC scrambled by a SI-RNTI
MO: PDCCH Monitoring Occasion for Type0-PDCCH CSS set
SIB1-R: (additional) SIB1 for reduced capability NR devices. May be limited to cases where it is generated as a separate TB from SIB1 and transmitted as a separate PDSCH.
CORESET #0-R: CORESET #0 for reduced capability NR devices
Type0-PDCCH-R CSS set: a search space set in which a redcap UE monitors a set of PDCCH candidates for a DCI format with CRC scrambled by a SI-RNTI
MO-R: PDCCH Monitoring Occasion for Type0-PDCCH CSS set
Cell defining SSB (CD-SSB): SSB containing RMSI scheduling information among NR SSBs
Non-cell defining SSB (non-CD-SSB): An SSB that is placed in the NR sync raster but does not contain RMSI scheduling information for the cell for measurement purposes. However, it may contain information indicating the location of the cell defining SSB.
SCS: subcarrier spacing
SI-RNTI: System Information Radio-Network Temporary Identifier
Camp on: “Camp on” is the UE state in which the UE stays on a cell and is ready to initiate a potential dedicated service or to receive an ongoing broadcast service.
TB: Transport Block
RSA (Redcap standalone): Cells that support only Redcap devices or services.
SIB1(—R)-PDSCH: PDSCH transmitting SIB1(—R)
SIB1(—R)-DCI: DCI for scheduling SIB1(—R)-PDSCH. DCI format 1_0 with CRC scrambled by SI-RNTI.
SIB1(—R)-PDCCH: PDCCH transmitting SIB1(—R)-DCI
FDRA: Frequency Domain Resource Allocation
TDRA: Time Domain Resource Allocation
RA: Random Access
MSGA: preamble and payload transmissions of the random access procedure for 2-step RA type.
MSGB: response to MSGA in the 2-step random access procedure. MSGB may consist of response(s) for contention resolution, fallback indication(s), and backoff indication.
RO-N: RO (RACH Occasion) for normal UE 4-step RACH and 2-step RACH (if configured)
RO-N1, RO-N2: When a separate RO is set for normal UE 2-step RACH, it is distinguished as RO-N1 (4-step) and RO-N2 (2-step).
RO—R: RO (RACH Occasion) set separately from RO-N for redcap UE 4-step RACH and 2-step RACH (if configured)
RO—R1, RO—R2: When a separate RO is set for redcap UE 2-step RACH, it is distinguished as RO—R1 (4-step) and RO—R2 (2-step).
PG-R: MsgA-Preambles Group for redcap UEs
RAR: Randoma Access Response
RAR window: the time window to monitor RA response(s)
FH: Frequency Hopping
iBWP: initial BWP
iBWP-DL(-UL): initial DL (UL) BWP
iBWP-DL(-UL)-R: (separate) initial DL (UL) BWP for RedCap
CS: Cyclic shift
NB: Narrowband

In the present disclosure, the term “set/setting” may be replaced with “configure/configuration”, and both may be used interchangeably. Further, a conditional expression (e.g., “if”, “in a case”, or “when”) may be replaced by “based on that” or “in a state/status”. In addition, an operation or software/hardware (SW/HW) configuration of a user equipment (UE)/base station (BS) may be derived/understood based on satisfaction of a corresponding condition. When a process on a receiving (or transmitting) side may be derived/understood from a process on the transmitting (or receiving) side in signal transmission/reception between wireless communication devices (e.g., a BS and a UE), its description may be omitted. Signal determination/generation/encoding/transmission of the transmitting side, for example, may be understood as signal monitoring reception/decoding/determination of the receiving side. Further, when it is said that a UE performs (or does not perform) a specific operation, this may also be interpreted as that a BS expects/assumes (or does not expect/assume) that the UE performs the specific operation. When it is said that a BS performs (or does not perform) a specific operation, this may also be interpreted as that a UE expects/assumes (or does not expect/assume) that the BS performs the specific operation. In the following description, sections, embodiments, examples, options, methods, schemes, proposals and so on are distinguished from each other and indexed, for convenience of description, which does not mean that each of them necessarily constitutes an independent disclosure or that each of them should be implemented only individually. Unless explicitly contradicting each other, it may be derived/understood that at least some of the sections, embodiments, examples, options, methods, schemes, proposals and so on may be implemented in combination or may be omitted.

In a wireless communication system, a user equipment (UE) receives information through downlink (DL) from a base station (BS) and transmit information to the BS through uplink (UL). The information transmitted and received by the BS and the UE includes data and various control information and includes various physical channels according to type/usage of the information transmitted and received by the UE and the BS.

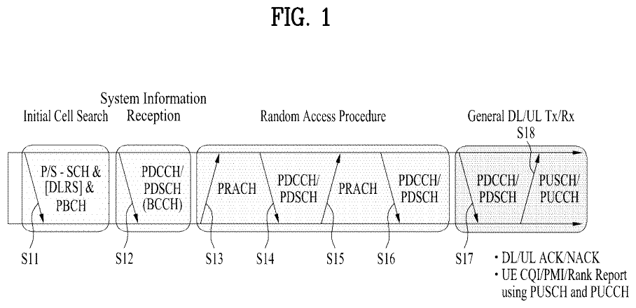

FIG. 1 illustrates physical channels used in a 3GPP NR system and a general signal transmission method using the same.

When a UE is powered on again from a power-off state or enters a new cell, the UE performs an initial cell search procedure, such as establishment of synchronization with a BS, in step S11. To this end, the UE receives a synchronization signal block (SSB) from the BS. The SSB includes a primary synchronization signal (PSS), a secondary synchronization signal (SSS), and a physical broadcast channel (PBCH). The UE establishes synchronization with the BS based on the PSS/SSS and acquires information such as a cell identity (ID). The UE may acquire broadcast information in a cell based on the PBCH. The UE may receive a DL reference signal (RS) in an initial cell search procedure to monitor a DL channel status.

The SSB is composed of four consecutive OFDM symbols, each carrying the PSS, the PBCH, the SSS/PBCH, or the PBCH. Each of the PSS and the SSS includes one OFDM symbol by 127 subcarriers, and the PBCH includes three OFDM symbols by 576 subcarriers. The PBCH is encoded/decoded based on Polar codes, and modulation/demodulation is performed thereon according to quadrature phase shift keying (QPSK). The PBCH in the OFDM symbol consists of data resource elements (REs) to which a complex modulation value of the PBCH is mapped, and demodulation reference signal (DMRS) REs to which a DMRS for the PBCH is mapped. Three DMRS REs are configured for each RB in the OFDM symbol, and three data REs configured between DMRS RES.

The PSS may be used in detecting a cell ID within a cell ID group, and the SSS may be used in detecting a cell ID group. The PBCH may be used in detecting an SSB (time) index and a half-frame. There are 336 cell ID groups, and each cell ID group includes three cell IDs. Thus, there are a total of 1008 cell IDs.

SSBs are periodically transmitted with an SSB periodicity. A default SSB periodicity assumed by the UE in initial cell search is defined as 20 ms. After cell access, the SSB periodicity may be set to one of {5 ms, 10 ms, 20 ms, 40 ms, 80 ms, and 160 ms} by the network (e.g., BS). An SSB burst set may be configured at the beginning of the SSB periodicity. The SSB burst set may be set to a time window of 5 ms (i.e., half-frame), and the SSB may be repeatedly transmitted up to L times within the SS burst set. The maximum number of SSB transmissions L may be given depending carrier frequency bands as follows. One slot includes up to two SSBs.
For frequency range up to 3 GHZ, L=4
For frequency range from 3 GHz to 6 GHZ, L=8
For frequency range from 6 GHz to 52.6 GHZ, L=64

The time-domain positions of candidate SSBs in the SS burst set may be defined depending on subcarrier spacings. The time-domain positions of the candidate SSBs are indexed from (SSB indices) 0 to L−1 in temporal order within the SSB burst set (i.e., half-frame).

Multiple SSBs may be transmitted within the frequency span of a carrier. Each SSB may not need to have a unique physical layer cell identifier, but different SSBs may have different physical layer cell identifiers.

The UE may acquire DL synchronization by detecting the SSB. The UE may identify the structure of the SSB burst set based on the detected SSB (time) index, and thus the UE may detect a symbol/slot/half-frame boundary. A frame/half-frame number to which the detected SSB belongs may be identified based on system frame number (SFN) information and half-frame indication information.

Specifically, the UE may obtain a 10-bit SFN for a frame to which a PBCH belongs from the PBCH. Then, the UE may obtain 1-bit half-frame indication information. For example, when the UE detects the PBCH in which the half-frame indication bit is set to 0, the UE may determine that an SSB to which the PBCH belongs is included in the first half-frame of the frame. When the UE detects the PBCH in which the half-frame indication bit is set to 1, the UE may determine that an SSB to which the PBCH belongs is included in the second half-frame of the frame. Finally, the UE may obtain the SSB index of the SSB to which the PBCH belongs based on a DMRS sequence and a PBCH payload carried by the PBCH.

After initial cell search, the UE may acquire more specific system information by receiving a physical downlink control channel (PDCCH) and receiving a physical downlink shared channel (PDSCH) based on information of the PDCCH in step S12.

System information (SI) is divided into a master information block (MIB) and a plurality of system information blocks (SIBs). The SI except for the MIB may be referred to as remaining minimum system information (RMSI). Details thereof will be described in the following.
The MIB includes information/parameters for monitoring a PDCCH scheduling a PDSCH carrying SIB1(SystemInformationBlock1), and the MIB is transmitted by the BS over the PBCH of an SSB. For example, the UE may check based on the MIB whether there is a CORESET for a Type0-PDCCH common search space. The Type0-PDCCH common search space is a kind of PDCCH search space, which is used to transmit a PDCCH scheduling an SI message. If the Type0-PDCCH common search space exists, the UE may determine (1) a plurality of contiguous RBs and one or more consecutive symbols included in the CORESET and (ii) a PDCCH occasion (e.g., a time-domain location for PDCCH reception, based on information (e.g., pdcch-ConfigSIB1) in the MIB. If the Type0-PDCCH common search space does not exist, pdcch-ConfigSIB1 provides information on a frequency location at which the SSB/SIB1 exists and information on a frequency range where there are no SSB/SIB1.
SIB1 includes information related to availability and scheduling (e.g., transmission periodicity, SI-window size, etc.) of the remaining SIBs (hereinafter referred to as SIBx where x is an integer more than or equal to 2). For example, SIB1 may indicate whether SIBx is periodically broadcast or provided at the request of the UE in an on-demand manner. When SIBx is provided in an on-demand manner, SIB1 may include information necessary for the UE to send an SI request. SIB1 is transmitted over a PDSCH, and a PDCCH scheduling SIB1 is transmitted in the Type0-PDCCH common search space. That is, SIB1 is transmitted over the PDSCH indicated by the PDCCH.
SIBx is included in the SI message and transmitted on the PDSCH. Each SI message is transmitted within a periodically occurring time window (i.e., SI-window).

The UE may perform a random access procedure (e.g., 4-step RA procedure) to access the BS in steps S13 to S16. For random access, the UE may transmit a preamble to the BS on a physical random access channel (PRACH) (S13) and receive a response message for preamble on a PDCCH and a PDSCH corresponding to the PDCCH (S14). In the case of contention-based random access, the UE may perform a contention resolution procedure by further transmitting the PRACH (S15) and receiving a PDCCH and a PDSCH corresponding to the PDCCH (S16).

Hereinafter, a 2-step random access procedure will be described in brief. In the 2-step random access procedure, S13/S15 may be performed in one step (where the UE performs transmission) (message A), and S14/S16 may be performed in one step (where the BS performs transmission) (message B). Message A (MsgA) may include a preamble and a payload (PUSCH payload), and the preamble and payload may be multiplexed based on time division multiplexing (TDM). In response to MsgA, message B (MsgB) may be transmitted for contention resolution, fallback indication(s), and/or backoff indication. The 2-step random access procedure may be subdivided into a contention-based random access (CBRA) procedure and a contention-free random access (CFRA) procedure. In the CFRA procedure, the BS may provide the UE with information on a preamble that the UE needs to transmit in MsgA and information on PUSCH allocation before the UE transmits MsgA.

After the foregoing procedure, the UE may receive a PDCCH/PDSCH (S17) and transmit a physical uplink shared channel (PUSCH)/physical uplink control channel (PUCCH) (S18), as a general downlink/uplink signal transmission procedure. Control information transmitted from the UE to the BS is referred to as uplink control information (UCI). The UCI includes hybrid automatic repeat and request acknowledgement/negative-acknowledgement (HARQ-ACK/NACK), scheduling request (SR), channel state information (CSI), etc. The CSI includes a channel quality indicator (CQI), a precoding matrix indicator (PMI), a rank indicator (RI), etc. While the UCI is transmitted on a PUCCH in general, the UCI may be transmitted on a PUSCH when control information and traffic data need to be simultaneously transmitted. In addition, the UCI may be aperiodically transmitted through a PUSCH according to request/command of a network.

The MR system may support signal transmission/reception in unlicensed bands. According to regional regulations for unlicensed bands, a communication node in an unlicensed band needs to determine whether a channel is used by other communication node(s) before transmitting a signal. Specifically, the communication node may perform carrier sensing (CS) before transmitting the signal so as to check whether the other communication node(s) perform signal transmission. When it is determined that the other communication node(s) perform no signal transmission, it is said that clear channel assessment (CCA) is confirmed. When a CCA threshold is predefined or configured by higher layer signaling (e.g., RRC signaling), the communication node may determine that the channel is busy if the detected channel energy is higher than the CCA threshold. Otherwise, the communication node may determine that the channel is idle. When it is determined that the channel is idle, the communication node may start the signal transmission in a UCell. The sires of processes described above may be referred to as Listen-Before-Talk (LBT) or a channel access procedure (CAP). The LBT and CAP may be interchangeably used in this document.

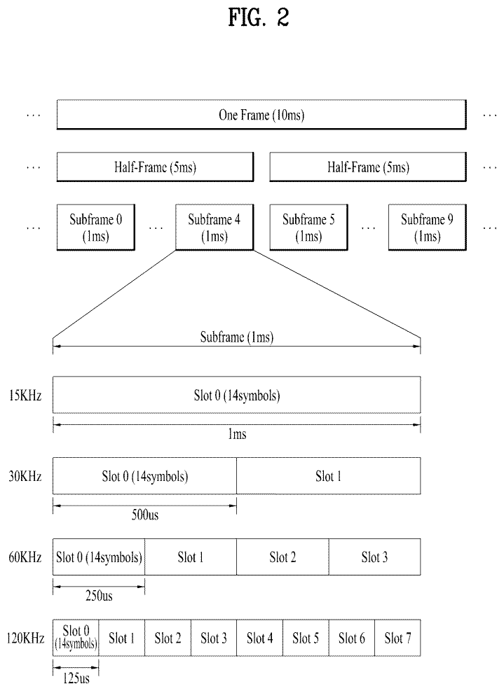

FIG. 2 illustrates a radio frame structure. In NR, uplink and downlink transmissions are configured with frames. Each radio frame has a length of 10 ms and is divided into two 5-ms half-frames (HF). Each half-frame is divided into five 1-ms subframes (SFs). A subframe is divided into one or more slots, and the number of slots in a subframe depends on subcarrier spacing (SCS). Each slot includes 12 or 14 Orthogonal Frequency Division Multiplexing (OFDM) symbols according to a cyclic prefix (CP). When a normal CP is used, each slot includes 14 OFDM symbols. When an extended CP is used, each slot includes 12 OFDM symbols.

Table 1 exemplarily shows that the number of symbols per slot, the number of slots per frame, and the number of slots per subframe vary according to the SCS when the normal CP is used.

TABLE 1

| SCS (15*2\hat{ }u) | N^{slot}_{symb} | N^{frame, u}ₛₗₒₜ | N^{subframe, u}ₛₗₒₜ |
|---|---|---|---|
| 15 KHz (u = 0) | 14 | 10 | 1 |
| 30 KHz (u = 1) | 14 | 20 | 2 |
| 60 KHz (u = 2) | 14 | 40 | 4 |
| 120 KHz (u = 3) | 14 | 80 | 8 |
| 240 KHz (u = 4) | 14 | 160 | 16 |

*N^{slot}_{symb}: Number of symbols in a slot
*N^{frame, u}ₛₗₒₜ: Number of slots in a frame
*N^{subframe, u}ₛₗₒₜ: Number of slots in a subframe

Table 2 illustrates that the number of symbols per slot, the number of slots per frame, and the number of slots per subframe vary according to the SCS when the extended CP is used.

TABLE 2

| SCS (15*2\hat{ }u) | N^{slot}_{symb} | N^{frame, u}ₛₗₒₜ | N^{subframe, u}ₛₗₒₜ |
|---|---|---|---|
| 60 KHz (u = 2) | 12 | 40 | 4 |

The structure of the frame is merely an example. The number of subframes, the number of slots, and the number of symbols in a frame may vary.

In the NR system, OFDM numerology (e.g., SCS) may be configured differently for a plurality of cells aggregated for one UE. Accordingly, the (absolute time) duration of a time resource (e.g., an SF, a slot or a TTI) (for simplicity, referred to as a time unit (TU)) consisting of the same number of symbols may be configured differently among the aggregated cells. Here, the symbols may include an OFDM symbol (or a CP-OFDM symbol) and an SC-FDMA symbol (or a discrete Fourier transform-spread-OFDM (DFT-s-OFDM) symbol).

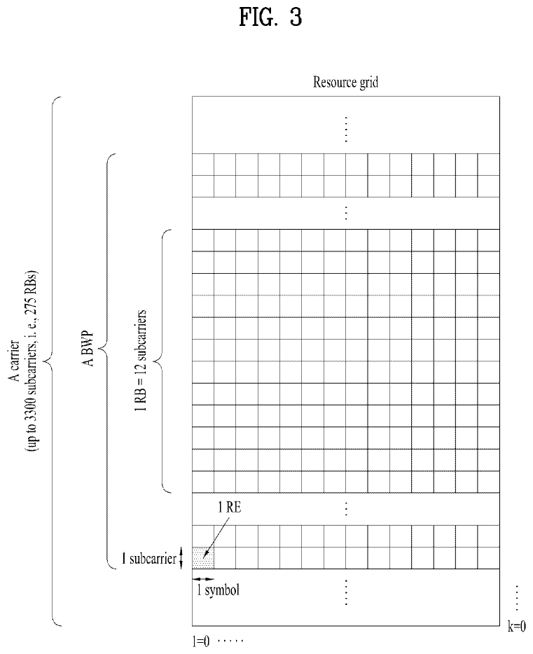

FIG. 3 illustrates a resource grid of a slot. A slot includes a plurality of symbols in the time domain. For example, when the normal CP is used, the slot includes 14 symbols. However, when the extended CP is used, the slot includes 12 symbols. A carrier includes a plurality of subcarriers in the frequency domain. A resource block (RB) is defined as a plurality of consecutive subcarriers (e.g., 12 consecutive subcarriers) in the frequency domain. A bandwidth part (BWP) may be defined to be a plurality of consecutive physical RBs (PRBs) in the frequency domain and correspond to a single numerology (e.g., SCS, CP length, etc.). The carrier may include up to N (e.g., 5) BWPs. Data communication may be performed through an activated BWP, and only one BWP may be activated for one UE. In the resource grid, each element is referred to as a resource element (RE), and one complex symbol may be mapped to each RE.

### Bandwidth Part (BWP)

In the NR system, up to 400 MHz may be supported per carrier. The network may instruct the UE to operate only in a part of the bandwidth of a wideband carrier, not the entire bandwidth, and the part of the bandwidth is called a bandwidth part (BWP). One or more BWPs may be configured in a carrier. In the frequency domain, a BWP is a subset of contiguous common resource blocks defined for a numerology in the bandwidth part on the carrier, and a numerology (e.g., subcarrier spacing, CP length, or slot/mini-slot duration) may be configured.

Activation/deactivation of DL/UL BWP or BWP switching may be performed based on network signaling and/or a timer (e.g., L1 signaling as a physical layer control signal, MAC control element (CE) as a MAC layer control signal, or RRC signaling, etc.). When the UE is in the initial access process or before the RRC connection of the UE is configured, the UE may not receive configuration for DL/UL BWP. In this case, the DL/UL BWP assumed by the UE is called an initially active DL/UL BWP.

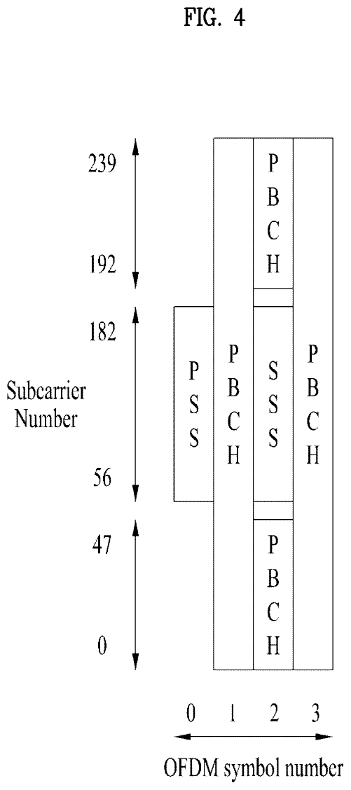

FIGS. 4 and 5 are drawings for explaining the structure and transmission method of an SSB (Synchronization Signal Block).

The UE may perform cell search, system information acquisition, beam alignment for initial access, DL measurement, and the like based on the SSB. Terms SSB the synchronization signal/physical broadcast channel (SS/PBCH) block will be interchangeably used.

Referring to FIG. 4, the SSB includes a PSS, an SSS, and a PBCH. The SSB includes four consecutive OFDM symbols, and the PSS, the PBCH, the SSS/PBCH, and the PBCH are transmitted in the respective OFDM symbols. Each of the PSS and the SSS includes one OFDM symbol by 127 subcarriers, and the PBCH includes three OFDM symbols by 576 subcarriers. Polar coding and QPSK are applied to the PBCH. The PBCH includes data REs and demodulation reference signal (DMRS) REs in every OFDM symbol. There are three DMRS REs per RB, with three data REs between every two adjacent DMRS REs.

Cell search is a process of acquiring time/frequency synchronization with a cell and detecting the identifier (ID) (e.g., physical cell ID (PCID)) of the cell. The PSS is used to detect a cell ID in a cell ID group, and the SSS is used to detect the cell ID group. The PBCH is used to detect an SSB (time) index and a half-frame.

The cell search process of the UE may be summarized in Table 3.

TABLE 3

| | Type of | |
|---|---|---|
| | Signals | Operations |
| 1st | PSS | *SS/PBCH block (SSB) symbol timing |
| Step | | acquisition* |
| | | Cell ID detection within a cell ID group (3 |
| | | hypothesis) |
| 2nd | SSS | Cell ID group detection (336 hypothesis) |
| Step | | |
| 3rd | PBCH | * SSB index and Half frame (HF) index |
| Step | DMRS | (Slot and frame boundary detection) |
| 4th | PBCH | * Time information (80 ms, System Frame |
| Step | | Number (SFN), SSB index, HF)* |
| | | Remaining Minimum System Information |
| | | (RMSI) Control resource set |
| | | (CORESET)/Search Space configuration) |
| 5th | PDCCH | * Cell access information* RACH |
| Step | and | configuration |
| | PDSCH | |

There may be 336 cell ID groups, each including three cell IDs. There may be 1008 cell IDs in total. Information about a cell ID group to which the cell ID of a cell belongs may be provided/obtained through the SSS of the cell, and information about the cell ID among 336 cells in the cell ID may be provided/obtained through the PSS.

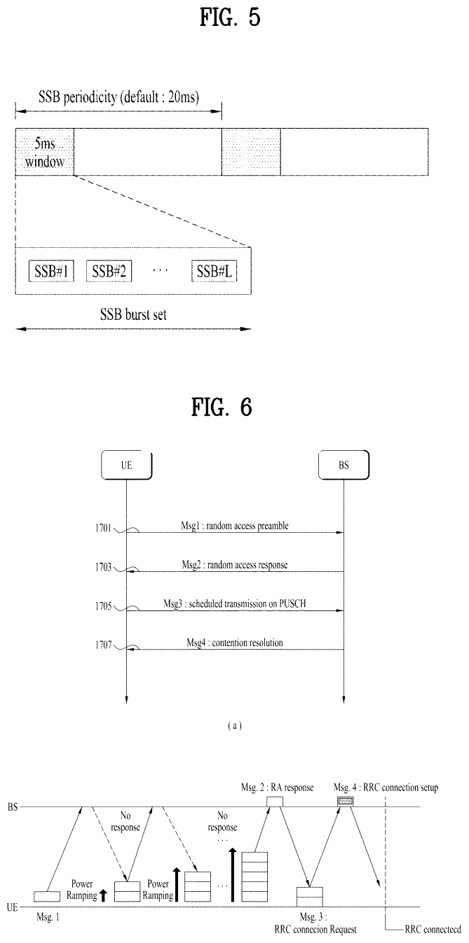

Referring to FIG. 6, an SSB is periodically transmitted according to an SSB periodicity. A basic SSB periodicity assumed by the UE in the initial cell search is defined as 20 ms. After cell access, the SSB periodicity may be set to one of {5 ms, 10 ms, 20 ms, 40 ms, 80 ms, 160 ms} by the network (e.g., the BS). An SSB burst set is configured at the beginning of an SSB period. The SSB burst set may be configured in a 5-ms time window (i.e., half-frame), and an SSB may be repeatedly transmitted up to L times within the SS burst set. The maximum number L of transmissions of the SSB may be given according to the frequency band of a carrier as follows. One slot includes up to two SSBs.
For frequency range up to 3 GHZ, L=4
   For frequency range from 3 GHz to 6 GHZ, L=8
   For frequency range from 6 GHz to 52.6 GHz, L=64

The time position of an SSB candidate in the SS burst set may be defined according to an SCS as follows. The time positions of SSB candidates are indexed as (SSB indexes) 0 to L−1 in temporal order within the SSB burst set (i.e., half-frame).
Case A: 15-kHz SCS: The indexes of the first symbols of candidate SSBs are given as {2, 8}+14*n where n=0, 1 for a carrier frequency equal to or lower than 3 GHZ, and n=0, 1, 2, 3 for a carrier frequency of 3 GHz to 6 GHz.
Case B: 30-kHz SCS: The indexes of the first symbols of candidate SSBs are given as {4, 8, 16, 20}+28*n where n=0 for a carrier frequency equal to or lower than 3 GHZ, and n=0, 1 for a carrier frequency of 3 GHz to 6 GHZ.
Case C: 30-kHz SCS: The indexes of the first symbols of candidate SSBs are given as {2, 8}+14*n where n=0, 1 for a carrier frequency equal to or lower than 3 GHZ, and n=0, 1, 2, 3 for a carrier frequency of 3 GHz to 6 GHz.
Case D: 120-kHz SCS: The indexes of the first symbols of candidate SSBs are given as {4, 8, 16, 20}+28*n where n=0, 1, 2, 3, 5, 6, 7, 8, 10, 11, 12, 13, 15, 16, 17, 18 for a carrier frequency above 6 GHz.
Case E: 240-kHz SCS: The indexes of the first symbols of candidate SSBs are given as {8, 12, 16, 20, 32, 36, 40, 44}+56*n where n=0, 1, 2, 3, 5, 6, 7, 8 for a carrier frequency above 6 GHz.

### Bandwidth Part (BWP)

The NR system may support up to 400 MHz for each carrier. The network may instruct the UE to operate only in a partial bandwidth rather than the whole bandwidth of such a wideband carrier. The partial bandwidth is referred to as a BWP. The BWP refers to a subset of contiguous common RBs defined for a numerology in the BWP of a carrier in the frequency domain, and one numerology (e.g., SCS, CP length, slot/mini-slot duration, etc.) may be configured.

The BS may configure multiple BWPs in one CC configured for the UE. For example, a BWP occupying a relatively small frequency region may be configured in a PDCCH monitoring slot, and a PDSCH indicated by the PDCCH in a larger BWP may be scheduled. Alternatively, when UEs are concentrated in a specific BWP, some of the UEs may be configured in another BWP for load balancing. Alternatively, a spectrum in the middle of the entire bandwidth may be punctured and two BWPs on both sides may be configured in the same slot in consideration of frequency-domain inter-cell interference cancellation between neighbor cells. That is, the BS may configure at least one DL/UL BWP for the UE associated with the wideband CC and activate at least one DL/UL BWP among the configured DL/UL BWP(s) at a specific time (through L1 signaling, MAC CE or RRC signaling, etc.). The BS may instruct the UE to switch to another configured DL/UL BWP (through L1 signaling, MAC CE or RRC signaling, etc.). Alternatively, when a timer expires, the UE may switch to a predetermined DL/UL BWP. The activated DL/UL BWP is defined as an active DL/UL BWP. The UE may fail to receive DL/UL BWP configuration during an initial access procedure or before an RRC connection is set up. A DL/UL BWP assumed by the UE in this situation is defined as an initial active DL/UL BWP.

FIG. 6 illustrates an exemplary normal random access procedure. Specifically, FIG. 6 shows a contention-based random access procedure of the UE, which is performed in four steps.

First, the UE may transmit message 1 (Msg1) including a random access preamble on a PRACH (see 1701 of FIG. 6(a)).

Random access preamble sequences with different lengths may be supported. A long sequence length of 839 may be applied to SCSs of 1.25 and 5 kHz, and a short sequence length of 139 may be applied to SCSs of 15, 30, 60, and 120 kHz.

Multiple preamble formats may be defined by one or more RACH OFDM symbols and different CPs (and/or guard times). A RACH configuration for a cell may be included in SI about the cell and provided to the UE. The RACH configuration may include information on the SCS of the PRACH, available preambles, preamble formats, and so on. The RACH configuration may include information about association between SSBs and RACH (time-frequency) resources. The UE transmits a random access preamble on a RACH time-frequency resource associated with a detected or selected SSB.

The threshold of an SSB for RACH resource association may be configured by the network, and a RACH preamble may be transmitted or retransmitted based on an SSB where reference signal received power (RSRP), which is measured based on the SSB, satisfies the threshold. For example, the UE may select one SSB from among SSBs that satisfy the threshold and transmit or retransmit the RACH preamble based on a RACH resource associated with the selected SSB.

Upon receiving the random access preamble from the UE, the BS may transmit message 2 (Msg2) corresponding to a random access response (RAR) message to the UE (see 1703 of FIG. 6(a)). A PDCCH scheduling a PDSCH carrying the RAR may be CRC masked with a random access (RA) radio network temporary identifier (RNTI) (RA-RNTI) and then transmitted. Upon detecting the PDCCH masked by the RA-RNTI, the UE may obtain the RAR from the PDSCH scheduled by DCI carried by the PDCCH. The UE may check whether the RAR includes RAR information in response to the preamble transmitted by the UE, i.e., Msg1. The presence or absence of the RAR information in response to Msg1 transmitted by the UE may be determined depending on whether there is a random access preamble ID for the preamble transmitted by the UE. If there is no response to Msg1, the UE may retransmit the RACH preamble within a predetermined number of times while performing power ramping. The UE may calculate PRACH transmit power for retransmitting the preamble based on the most recent path loss and power ramping counter.

The RAR information transmitted on the PDSCH may include timing advance (TA) information for UL synchronization, an initial UL grant, and a temporary cell-RNTI (C-RNTI). The TA information may be used to control a UL signal transmission timing. The UE may transmit a UL signal over a UL shared channel as message 3 (Msg3) of the random access procedure based on the RAR information (see 1705 of FIG. 6(a)). Msg3 may include an RRC connection request and a UE identifier. In response to Msg3, the network may transmit message 4 (Msg4), which may be treated as a contention resolution message on DL (see 1707 of FIG. 6(a)). Upon receiving Msg4, the UE may enter the RRC_CONNECTED state.

On the other hand, a contention-free random access procedure may be performed when the UE is handed over to another cell or BS or when it is requested by the BS. In the contention-free random access procedure, a preamble to be used by the UE (hereinafter referred to as a dedicated random access preamble) is allocated by the BS. Information on the dedicated random access preamble may be included in an RRC message (e.g., handover command) or provided to the UE through a PDCCH order. When the random access procedure is initiated, the UE may transmit the dedicated random access preamble to the BS. When the UE receives an RAR from the BS, the random access procedure is completed.

As described above, a UL grant in the RAR may schedule PUSCH transmission to the UE. A PUSCH carrying initial UL transmission based on the UL grant in the RAR is referred to as an Msg3 PUSCH. The content of an RAR UL grant may start at the MSB and end at the LSB, and the content may be given as shown in Table 4.

TABLE 4

| RAR UL grant field | Number of bits |
|---|---|
| Frequency hopping flag | 1 |
| Msg3 PUSCH frequency resource allocation | 12 |
| Msg3 PUCH time resource allocation | 4 |
| Modulation and coding scheme (MCS) | 4 |
| Transmit power control (TPC) for Msg3 PUSCH | 3 |
| CSI request | 1 |

In a contention-free random access (CFRA) procedure, the CSI request field in the RAR UL grant indicates whether the UE includes aperiodic CSI reporting in the corresponding PUSCH transmission. a subcarrier spacing for Msg3 PUSCH transmission is provided by the RRC parameter. The UE may transmit PRACH and Msg3 PUSCH on the same uplink carrier in the same service providing cell. A UL BWP for Msg3 PUSCH transmission is indicated by SystemInformationBlock1 (SIB1).

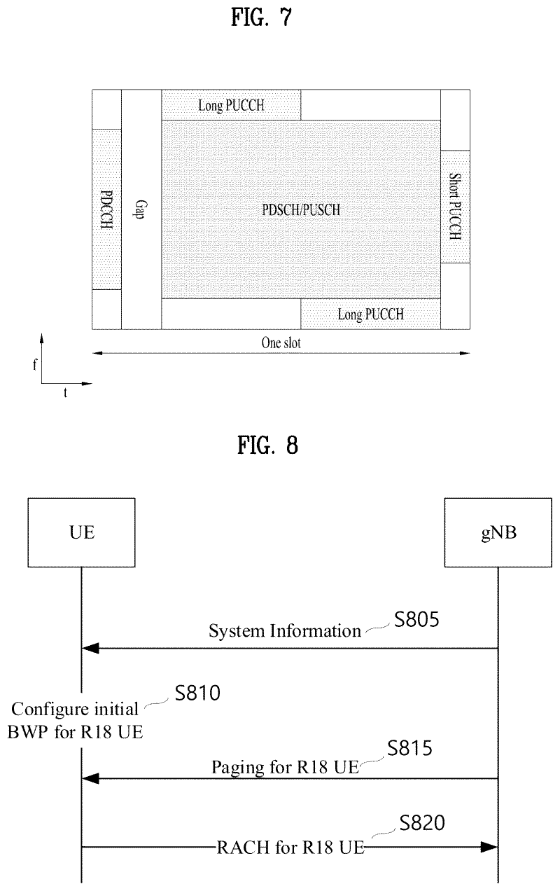

FIG. 7 illustrates exemplary mapping of physical channels in a slot.

Referring to FIG. 7, a PDCCH may be transmitted in a DL control region, and a PDSCH may be transmitted in a DL data region. A PUCCH may be transmitted in a UL control region, and a PUSCH may be transmitted in a UL data region. A guard period (GP) provides a time gap for transmission mode-to-reception mode switching or reception mode-to-transmission mode switching at a BS and a UE. Some symbol at the time of DL-to-UL switching in a subframe may be configured as a GP.

Each physical channel will be described below in greater detail.

The PDCCH delivers DCI. For example, the PDCCH (i.e., DCI) may carry information about a transport format and resource allocation of a DL shared channel (DL-SCH), resource allocation information of an uplink shared channel (UL-SCH), paging information on a paging channel (PCH), system information on the DL-SCH, information on resource allocation of a higher-layer control message such as an RAR transmitted on a PDSCH, a transmit power control command, information about activation/release of configured scheduling, and so on. The DCI includes a cyclic redundancy check (CRC). The CRC is masked with various identifiers (IDs) (e.g. a radio network temporary identifier (RNTI)) according to an owner or usage of the PDCCH. For example, if the PDCCH is for a specific UE, the CRC is masked by a UE ID (e.g., cell-RNTI (C-RNTI)). If the PDCCH is for a paging message, the CRC is masked by a paging-RNTI (P-RNTI). If the PDCCH is for system information (e.g., a system information block (SIB)), the CRC is masked by a system information RNTI (SI-RNTI). When the PDCCH is for an RAR, the CRC is masked by a random access-RNTI (RA-RNTI).

The PDCCH includes 1, 2, 4, 8, or 16 control channel elements (CCEs) according to its aggregation level (AL). A CCE is a logical allocation unit used to provide a PDCCH with a specific code rate according to a radio channel state. A CCE includes 6 resource element groups (REGs), each REG being defined by one OFDM symbol by one (P) RB. The PDCCH is transmitted in a control resource set (CORESET). A CORESET is defined as a set of REGs with a given numerology (e.g., an SCS, a CP length, and so on). A plurality of CORESETs for one UE may overlap with each other in the time/frequency domain. A CORESET may be configured by system information (e.g., a master information block (MIB)) or UE-specific higher-layer signaling (e.g., radio resource control (RRC) signaling). Specifically, the number of RBs and the number of symbols (3 at maximum) in the CORESET may be configured through higher-layer signaling.

For PDCCH reception/detection, the UE monitors PDCCH candidates. A PDCCH candidate is CCE(s) that the UE should monitor to detect a PDCCH. Each PDCCH candidate is defined as 1, 2, 4, 8, or 16 CCEs according to an AL. The monitoring includes (blind) decoding PDCCH candidates. A set of PDCCH candidates decoded by the UE are defined as a PDCCH search space (SS). An SS may be a common search space (CSS) or a UE-specific search space (USS). The UE may obtain DCI by monitoring PDCCH candidates in one or more SSs configured by an MIB or higher-layer signaling. Each CORESET is associated with one or more SSs, and each SS is associated with one CORESET. An SS may be defined based on the following parameters.
controlResourceSetId: A CORESET related to an SS.
monitoringSlotPeriodicity AndOffset: A PDCCH monitoring periodicity (in slots) and a PDCCH monitoring offset (in slots).
monitoringSymbols WithinSlot: PDCCH monitoring symbols in a slot (e.g., the first symbol(s) of a CORESET).
nrofCandidates: The number of PDCCH candidates (one of 0, 1, 2, 3, 4, 5, 6, and 8) for each AL={1, 2, 4, 8, 16}.

* An occasion (e.g., time/frequency resources) in which the UE is to monitor PDCCH candidates is defined as a PDCCH (monitoring) occasion. One or more PDCCH (monitoring) occasions may be configured in a slot.

Table 5 shows the characteristics of each SS.

TABLE 5

| | Search | | |
|---|---|---|---|
| Type | Space | RNTI | Use Case |
| Type0-PDCCH | Common | SI-RNTI on a primary cell | SIB Decoding |
| Type0A-PDCCH | Common | SI-RNTI on a primary cell | SIB Decoding |
| Type1-PDCCH | Common | RA-RNTI or TC-RNTI on a primary cell | Msg2, Msg4 |
| | | | decoding in |
| | | | RACH |
| Type2-PDCCH | Common | P-RNTI on a primary cell | Paging Decoding |
| Type3-PDCCH | Common | INT-RNTI, SFI-RNTI, TPC-PUSCH-RNTI, | |
| | | TPC-PUCCH-RNTI, TPC-SRS-RNTI, C-RNTI, | |
| | | MCS-C-RNTI, or CS-RNTI(s) | |
| | UE Specific | C-RNTI, or MCS-C-RNTI, or CS-RNTI(s) | User specific |
| | | | PDSCH decoding |

Table 5 shows DCI formats transmitted on the PDCCH.

TABLE 6

| DCI | |
|---|---|
| format | Usage |
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM symbol(s) |
| | where UE may assume no transmission is intended for the UE |
| 2_2 | Transmission of TPC commands for PUCCH and PUSCH |
| 2_3 | Transmission of a group of TPC commands for SRS |
| | transmissions by one or more UEs |

DCI format 0_0 may be used to schedule a TB-based (or TB-level) PUSCH, and DCI format 0_1 may be used to schedule a TB-based (or TB-level) PUSCH or a code block group (CBG)-based (or CBG-level) PUSCH. DCI format 1_0 may be used to schedule a TB-based (or TB-level) PDSCH, and DCI format 1_1 may be used to schedule a TB-based (or TB-level) PDSCH or a CBG-based (or CBG-level) PDSCH (DL grant DCI). DCI format 0_0/0_1 may be referred to as UL grant DCI or UL scheduling information, and DCI format 1_0/1_1 may be referred to as DL grant DCI or DL scheduling information. DCI format 2_0 is used to deliver dynamic slot format information (e.g., a dynamic slot format indicator (SFI)) to a UE, and DCI format 2_1 is used to deliver DL pre-emption information to a UE. DCI format 2_0 and/or DCI format 2_1 may be delivered to a corresponding group of UEs on a group common PDCCH which is a PDCCH directed to a group of UEs.

DCI format 0_0 and DCI format 1_0 may be referred to as fallback DCI formats, whereas DCI format 0_1 and DCI format 1_1 may be referred to as non-fallback DCI formats. In the fallback DCI formats, a DCI size/field configuration is maintained to be the same irrespective of a UE configuration. In contrast, the DCI size/field configuration varies depending on a UE configuration in the non-fallback DCI formats.

The PDSCH conveys DL data (e.g., DL-shared channel transport block (DL-SCH TB)) and uses a modulation scheme such as quadrature phase shift keying (QPSK), 16-ary quadrature amplitude modulation (16QAM), 64QAM, or 256QAM. A TB is encoded into a codeword. The PDSCH may deliver up to two codewords. Scrambling and modulation mapping may be performed on a codeword basis, and modulation symbols generated from each codeword may be mapped to one or more layers. Each layer together with a demodulation reference signal (DMRS) is mapped to resources, and an OFDM symbol signal is generated from the mapped layer with the DMRS and transmitted through a corresponding antenna port.

The PUCCH delivers uplink control information (UCI). The UCI includes the following information.
SR (Scheduling Request): Information used to request UL-SCH resources.
HARQ (Hybrid Automatic Repeat reQuest)-ACK (Acknowledgement): A response to a DL data packet (e.g., codeword) on the PDSCH. An HARQ-ACK indicates whether the DL data packet has been successfully received. In response to a single codeword, a 1-bit of HARQ-ACK may be transmitted. In response to two codewords, a 2-bit HARQ-ACK may be transmitted. The HARQ-ACK response includes positive ACK (simply, ACK), negative ACK (NACK), discontinuous transmission (DTX) or NACK/DTX. The term HARQ-ACK is interchangeably used with HARQ ACK/NACK and ACK/NACK.
CSI (Channel State Information): Feedback information for a DL channel. Multiple input multiple output (MIMO)-related feedback information includes an R1 and a PMI.

The PUSCH delivers UL data (e.g., UL-shared channel transport block (UL-SCH TB)) and/or UCI based on a CP-OFDM waveform or a DFT-s-OFDM waveform. When the PUSCH is transmitted in the DFT-s-OFDM waveform, the UE transmits the PUSCH by transform precoding. For example, when transform precoding is impossible (e.g., disabled), the UE may transmit the PUSCH in the CP-OFDM waveform, while when transform precoding is possible (e.g., enabled), the UE may transmit the PUSCH in the CP-OFDM or DFT-s-OFDM waveform. A PUSCH transmission may be dynamically scheduled by a UL grant in DCI, or semi-statically scheduled by higher-layer (e.g., RRC) signaling (and/or Layer 1 (L1) signaling such as a PDCCH) (configured scheduling or configured grant). The PUSCH transmission may be performed in a codebook-based or non-codebook-based manner.

### Narrower DL BWP for System Information and Paging

In addition to the recent 5G main use cases (mMTC, eMBB, and URLLC), the importance/interest in use case areas spanning mMTC and eMBB, or mMTC and URLLC, has increased. These use cases may include connected industries, smart cities, and wearables. To support the use cases more efficiently in terms of terminal cost/complexity, and power consumption in a wireless communication system, a new type of terminal that is distinct from the conventional NR terminal has been introduced. This new type of terminal is called Reduced Capability NR terminal (hereinafter referred to as RedCap UE/terminal, or RedCap), and to distinguish the new type of terminal from the conventional NR terminal, the existing NR terminal is called non-RedCap UE/terminal, or non-RedCap. The RedCap terminal is more inexpensive and has lower power consumption than the non-RedCap terminal, and in detail, may have all or some of the following features.

A. Complexity reduction related features:
Reduced maximum UE Bandwidth
Reduced number of UE RX/TX branches/antennas
Half-Duplex-FDD
Relaxed UE processing time
Relaxed UE processing capability
   B. Power saving related features:
Extended DRX for RRC inactive and/or idle
RRM relaxation for stationary devices

Target use cases for the Redcap terminal with the features may include:

### 1) Connected Industries

Sensors and actuators connected to 5G network and core
massive Industrial Wireless Sensor Network (IWSN)
Relatively low-cost service that requires small device form factor with battery life of several years, as well as URLLC service with very high requirements.
The requirements for this service are higher than Low Power Wide Area (LPWA) (i.e., LTE-M/NB-IoT) but lower than URLCC and eMBB.
Pressure sensor, humidity sensor, thermometer, motion sensor, accelerometer, actuator, and the like

### 2) Smart City

Data collection and processing to monitor and control urban resources more efficiently and provide services
Necessary surveillance camera for smart city as well as factory and industrial complex

### 3) Wearables

Smart watch, ring, eHealth related device, medical monitoring device, and the like
Small device, and the like

The RedCap terminal may have lower transmit and receive performance than the non-RedCap terminal. The main cause is decrease in frequency diversity performance due to a decrease in terminal bandwidth, and decrease in performance may become greater as a supported terminal bandwidth decreases.

Considering RedCap main use cases such as wearables and massive wireless sensors, massive connections need to be supported through a narrow bandwidth, and thus traffic congestion problems are expected.

To resolve the problems, a method that supports terminal frequency hopping (hereinafter FH) and traffic offloading (hereinafter TO) is proposed.

In this specification, ‘( )’ may be interpreted both as excluding the contents within ( ) and as including the contents within the parentheses. In this specification, ‘/’ may mean including all of the contents separated by/(and) or including only some of the separated contents (or).

### a Plurality of RedCap UE Types and BWP Modes

The following different RedCap UE types are supported in this specification. In particular, at least the following two types are supported.
(1) Rel.17 RedCap UE (hereinafter, Rel.17 R-UE): Rel.17 R-UE supporting BWP of 20 MHz
(2) Rel. 18 RedCap UE (hereinafter, Rel.18 R-UE): Rel. 18 R-UE supporting BWP of 5 MHz (or sub-BWP of 5 MHz or BW location of 5 MHz).
1) Option BW1: Both RF and BaseBand (BB) bandwidths of UE support 5 MHz for UL/DL.
2) Option BW2: The UE supports BB bandwidth of 5 MHz and RF bandwidth of 20 MHz for all UL/DL signals/channels.
3) Option BW3: Only BB bandwidth of 5 MHz is supported for PDSCH (unicast/broadcast PDSCH) and PUSCH, and RF bandwidth of 20 MHz is supported for UL/DL. However, up to UE RF of 20 MHz+BB bandwidth is supported for other physical channels and signals.

In this specification, Rel. 18 PDSCH or DCI may mean PDSCH or DCI for Rel. 18 R-UE. Rel-17 PDSCH or legacy PDSCH or pre-Rel. 18 PDSCH may mean a PDSCH for a Rel. 17 R-UE or a non-RedCap UE regardless of release, and Rel-17 DCI or legacy DCI or pre-Rel. 18 DCI may mean DCI for an Rel. 17 R-UE or a non-RedCap UE regardless of release.

In this specification, the BWP for Rel. 18 R-UE may be replaced by a sub-BWP or a BW location, and may have a size of 5 MHz or less.

FIG. 8 shows a flow of a signal transmission and reception method according to one embodiment.

Referring to FIG. 8, the UE may receive system information (805). The UE may configure an initial BWP (810). The UE may receive a paging signal from a BS (815) and perform a RACH procedure for initial access from the BS (820).

In detail, the UE may usually configure/activate one initial BWP when in RRC_IDLE or RRC_INACTIVE state, and perform the initial access procedure/process through the initial BWP in the activated state. For the R18 RedCap UE, the BS may allocate a PDSCH by dividing the initial BWP for a normal UE and/or the R17-initial BWP for the R17 RedCap UE into N BWPs of 5 MHz. For example, when an R18 RedCap UE is capable of only receiving PDSCH transmissions up to 5 MHz, an initial BWP of 20 MHz may be divided into N sub-BWPs of 5 MHz and Rel-18 PDSCH(s) may be transmitted through one or more specific sub-BWPs of 5 MHz of the initial BWP of 20 MHz for system information transmission and/or paging transmission.

The R18 RedCap UE may be explicitly configured with a plurality of sub-BWPs of 5 MHz separated within an initial BWP of 20 MHz or an initial BWP for a normal UE, or may be allocated a frequency resource corresponding to a sub-BWP (hereinafter, bandwidth) of 5 MHz within an initial BWP of 20 MHz or the initial BWP for the normal UE without explicitly separated configuration for a plurality of sub-BWPs of 5 MHz. Hereinafter, for convenience of explanation, it is assumed that the R18 RedCap UE is configured with a plurality of sub-BWPs of 5 MHz separated within a specific BWP, but the present disclosure is not limited thereto, and it may also be applied to a case in which a sub-BWP 5 MHz or a frequency bandwidth of 5 MHz is indicated through a resource allocation method without explicitly separated configuration.

### Method of Configuring One or More Sub-BWPs

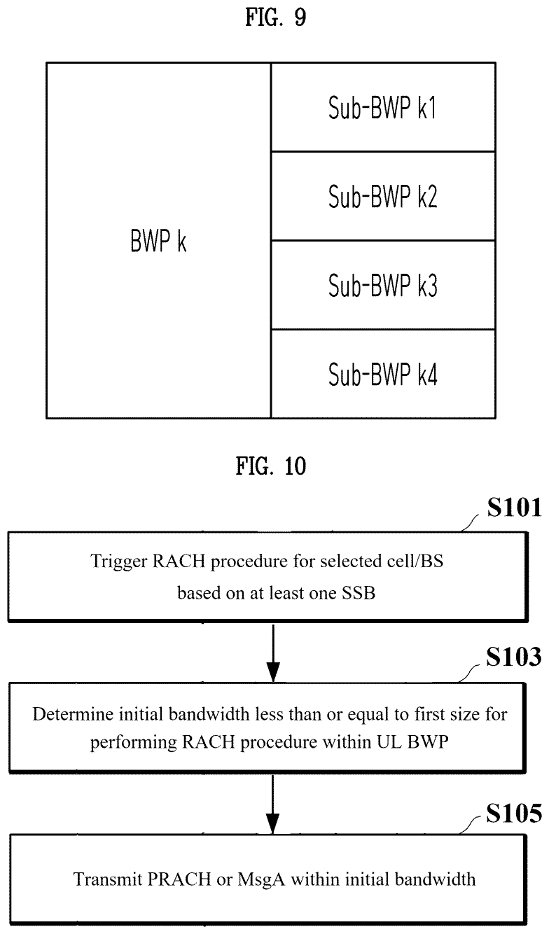

FIG. 9 is a diagram for explaining a method of configuring a plurality of sub-BWPs in one BWP.

Referring to FIG. 9, a UE in RRC_CONNECTED state may have up to four UE-dedicated BWPs (or sub-BWPs) configured for one BWP. In this case, the UE may activate only one sub-BWP from among the four sub-BWPs. For example, a BS may configure up to N sub-BWPs for a specific BWP k for a UE. (N=1, 2, 3, 4 . . . ). In this case, the sub-BWPs may be configured to not overlap each other (non-overlapped sub-BWPs) as shown in FIG. 9, or may be configured to overlap in entirely/partially.

For example, when the one BWP is a BWP of 8 MHz, the sub-BWPs may be configured as a sub-BWP of 5 MHz and a sub-BWP of 3 MHz not to overlap each other within 8 MHz. Alternatively, the sub-BWPs may be configured as a sub-BWP of 4 Mhz and a sub-BWP of 4 Mhz that do not overlap each other within a BWP of 8 Mhz, or as a sub-BWP of 5 Mhz and a sub-BWP of 5 Mhz that partially overlap each other. In this case, each sub-BWP may be configured in the following method.
(1) Method 1: A BS may indicate a starting PRB and the number of PRBs (consecutive PRBs) for each sub-BWP. The starting PRB of a sub-BWP may be indicated/configured via a relative offset to the starting PRB of a specific BWP connected to the sub-BWP.
(2) Method 2: A BS may configure sub-BWPs according to a value of N by indicating the number of sub-BWPs N for a specific BWP. When M PRBs constituting a specific BWP are divided into N sub-BWPs, each sub-BWP may be configured to include PRBs equal to the Ceiling (M/N) or Floor (M/N) value.
For example, each sub-BWP may include PRBs corresponding to the number of PRBs calculated based on Ceiling (M/N). For example, when M=5 and N=2, Ceiling (M/N)=3, and thus each sub-BWP includes three PRBs, and from among five PRBs of a specific BWP, the lower three PRBs (i.e., the three PRBs with relatively low PRB indices) are allocated to the first sub-BWP, and the upper three PRBs (i.e., the three PRBs with relatively high PRB indices) are allocated to the second sub-BWP. In this case, the third PRB of the specific BWP may be configured as a frequency resource in which two sub-BWPs overlap each other.
Each sub-BWP may include PRBs corresponding to the number of PRBs calculated based on Floor (M/N). For example, when M=5 and N=2, Floor (M/N)=2, and thus each sub-BWP includes two PRBs, and from among five PRBs of a specific BWP, the lower two PRBs (i.e., the two PRBs with relatively low PRB indices) are allocated to the first sub-BWP, and the upper two PRBs (i.e., the two PRBs with relatively high PRB indices) are allocated to the second sub-BWP. In this case, the third PRB of the specific BWP may be configured as a guard frequency resource (or guard band) that does not belong to any sub-BWP.

Alternatively, when two or more sub-BWPs are configured for a specific BWP, a specific sub-BWP may be designated as a first active sub-BWP (or default sub-BWP, initial sub-BWP, default BW location, or associated sub-BWP) via an RRC message (or MAC CE, or DCI). As such, when the first active sub-BWP is configured in a specific BWP of a specific cell, the UE may activate/configure the first active sub-BWP of the specific BWP or switch the BWP to the first active sub-BWP of the specific BWP. Thereafter, the UE may transmit a PUSCH in the first active sub-BWP indicated/configured for a specific UL BWP, and receive a PDCCH and/or a PDSCH in the first active sub-BWP indicated/configured for a specific DL BWP.

### Method of Selecting UL/DL Sub-BWP During Initial Access

A UE in RRC_IDLE or RRC_INACTIVE state may switch to RRC_CONNECTED mode through initial access. Alternatively, when the UE performs an RRC re-establishment process due to Radio Link Failure (RLF) and the like, the UE may perform an initial access procedure. Alternatively, the UE may perform an initial access procedure to a target cell through a mobility process such as handover.

When performing RACH, which is an initial access procedure, the UE may first select an initial DL/UL BWP, select a sub-BWP of an initial UL BWP, and perform PRACH preamble and/or MSG3 (or MSG A) PUSCH transmission in the selected sub-BWP of the initial UL BWP. The UE may also select a sub-BWP for the initial DL BWP to receive MSG2 (or MSG B) and/or MSG4 PDCCH/PDSCH. Thereafter, the UE may perform DL reception/UL transmission through the selected sub-BWP (or initial sub-BWP) until a separate reconfiguration message is received.

In this case, the R18 R-UE may be configured to a separate initial (sub) BWP different from the existing UEs, and when there is no separate initial BWP, the initial BWP configured for the R17 R-UE may be selected. When the initial BWP for the R17/18 R-UE is not configured, the R18 R-UE may select the initial BWP configured for a normal UE. When configured grant (CG) based small data transmission (SDT) is supported, the UE may select a sub-BWP as described below, transmit a PUSCH for CG-SDT instead of transmission of a PRACH preamble and/or MSG3/A PUSCH in the selected sub-BWP, and receive a PDCCH/PDSCH.

>Based on system information received by the UE, it may be determined that only one sub-BWP is configured within the initial UL BWP. Alternatively, there may be a first active sub-BWP (or default sub-BWP or a specified 5 Mhz BW) configured within the initial UL BWP. In this case, the UE may perform transmission of the PRACH preamble and/or MSG3/A PUSCH in one sub-BWP or the first active sub-BWP. For example, when only one sub-BWP is configured within the initial UL BWP, the UE may transmit the PRACH preamble (or MGS A) in the one sub-BWP. Alternatively, when a plurality of sub-BWPs are configured within the initial UL BWP, the UE may transmit a PRACH preamble (or MGS A) in a sub-BWP configured as a first active sub-BWP (or default sub-BWP or a designated 5 MHz BW) from among the plurality of sub-BWPs.
The BS may configure different sub-BWPs within the initial UL BWP according to a UE type or UE capability in the system information. Here, the UE type or UE capability may be related to a processing time, Radio Frequency Bandwidth (RF BW), maximum TB size, maximum bit rate, and/or number of antennas supported by the UE. In this case, the UE may select a sub-BWP mapped within an initial UL BWP configured (via the BS) based on the type or capability of the UE, and perform transmission of a PRACH preamble and/or MSG3/A PUSCH in the selected sub-BWP. For example, a UE based on the Option BW3 described above may configure the first sub-BWP within the initial UL BWP as a sub-BWP for transmission of a PRACH or the like, and a UE based on Option BW2 described above may configure the second sub-BWP within the initial UL BWP as a sub-BWP for transmission of a PRACH, and the like. Alternatively, a UE supporting a general processing time may configure the first sub-BWP within the initial UL BWP as a sub-BWP for transmission of PRACH, and the like, and a UE having a more limited processing time than the general case may configure the second sub-BWP within the initial UL BWP as a sub-BWP for transmission of PRACH, and the like.
The BS may configure different sub-BWPs within the initial UL BWP according to a service in the system information or according to the establishment cause or re-establishment cause of the initial access. In this case, the UE may select a sub-BWP mapped within the initial UL BWP based on the cause for which the initial access is triggered to perform transmission of the PRACH preamble and/or MSG3/A PUSCH. For example, with respect to the service, a first sub-BWP may be configured as a sub-BWP mapped within the initial UL BWP for a mobile originating call, a second sub-BWP may be configured as a sub-BWP mapped within the initial UL BWP for a mobile terminating call, a third sub-BWP may be configured as a sub-BWP mapped within the initial UL BWP for an emergency call, and a fourth sub-BWP may be configured as a sub-BWP mapped within the initial UL BWP for a high priority call.
The BS and the UE may configure/select the first active sub-BWP (or, first DL active sub-BWP) within the initial DL BWP in the same manner as the configuration/selection method of the first active sub-BWP within the initial UL BWP. For example, a BS may configure different sub-BWPs within an initial DL BWP based on a UE type, UE capability, service, establishment cause of initial access, and/or re-establishment cause. In this case, the UE may select one sub-BWP configured within the initial DL BWP based on a UE type and UE capability thereof, a trigger cause of the initial access, and the like. The UE may transmit MSG2/B or receive MSG4 PDCCH/PDSCH through the selected sub-BWP.
>When a plurality of sub-BWPs are configured within the initial UL BWP according to system information but there is no separate configuration for the first active sub-BWP, the UE may select/activate one of the plurality of sub-BWPs. The UE may transmit a PRACH preamble and/or MSG3/A PUSCH through the selected sub-BWP. In detail, the UE may randomly select one sub-BWP from among the plurality of sub-BWPs, select one sub-BWP based on a UE ID, probabilistically select one sub-BWP, or select one sub-BWP based on a measurement result for a beam (or a serving cell).
For example, the BS may configure a probability value between 0 and x1 for the first sub-BWP, and a probability value between x1 and 1 for the second sub-BWP. In this case, the UE may randomly select a prime number between 0 and 1 with uniform probability, and select a first or second sub-BWP depending on whether the selected value is greater than or less than x1.
Alternatively, when the BS configures M sub-BWPs in the initial UL BWP, the UE may calculate the ‘UE ID mod M’ result value based on a UE ID thereof, and select/configure the first sub-BWP when the result value is 0, and select/configure the second sub-BWP when the result value is 1. The UE may select/configure the last M^{th} sub-BWP when the result value is M−1 in the ascending order of the result values. Alternatively, this configuring process may proceed in descending order of the result values, in which case the UE may select/configure the first sub-BWP when the result value is M−1, and select/configure the last M-th sub-BWP when the result value is 1 in descending order of the result values.
Alternatively, the BS may configure a specific threshold to map a specific SSB index to SSB beams based on N SSB indices indicated in SIB1 (System Information Block 1). Alternatively, the BS may configure a specific threshold for SSB beams based on N SSB indices indicated in SIB1 (System Information Block 1). In this case, the UE may measure Reference Signals Received Power (RSRP) or Reference Signal Received Quality (RSRQ) for each of the SSBs, and select an SSB (or an index of an SSB) having the most appropriate measurement value from among at least one SSB having a measurement value higher than a specific threshold based on the measurement result, or may randomly select one SSB (or an index of an SSB). In this case, the UE may transmit the PRACH preamble and/or MSG3/A PUSCH through (one) sub-BWP (i.e., the initial sub-BWP) mapped to the selected SSB or SSB index from among the plurality of sub-BWPs. When there is no SSB or SSB index having a measurement value (or quality) equal to or greater than the specific threshold, the UE may randomly select one SSB index from among the N SSB indexes and transmit a PRACH preamble and/or MSG3/A PUSCH through a sub-BWP mapped to the selected SSB index.
Alternatively, the BS and the UE may configure/select the first active sub-BWP (or, first DL active sub-BWP) within the initial DL BWP in the same manner as the configuration/selection method of the first active sub-BWP within the initial UL BWP. For example, when a plurality of sub-BWPs are configured for the initial DL BWP, similar to the method described above, the UE may randomly select a sub-BWP, select a sub-BWP based on a UE ID, probabilistically select a sub-BWP, or select a sub-BWP based on a measurement result for a beam (or serving cell). Then, the UE may receive a PDCCH/PDSCH for MSG2/B or MSG4 through the selected sub-BWP (or, first DL active sub-BWP).
> The following alternative method may also be considered for selecting a first DL active sub-BWP within the initial DL BWP connected to the initial UL BWP. In the alternative method, the BS may map between M sub-BWPs within an initial UL BWP and k sub-BWPs within an initial DL BWP. For example, a particular UL sub-BWP may be mapped to one or more DL sub-BWPs, or a particular DL sub-BWP may be mapped to one or more UL sub-BWPs. In this case, the UE may select a first active sub-BWP from among M sub-BWPs within the initial UL BWP in one of the methods, select a DL sub-BWP mapped to the selected first active sub-BWP for UL, and configure the selected DL sub-BWP as the first active sub-BWP for DL within the initial DL BWP. Then, the UE may perform PDCCH monitoring and/or PDSCH reception through the first active sub-BWP for DL within the initial DL BWP.

### Frequency Hopping Method of BWP and Sub-BWP

A BS may separately configure an initial UL/DL BWP into a plurality of overlapped or non-overlapped sub-BWPs for a UE RRC_IDLE or RRC_INACTIVE state. The BS may separately configure one or more UL/DL BWPs for a UE in RRC_CONNECTED state into a plurality of overlapped or non-overlapped sub-BWPs.

As such, when an active BWP of the UE is separately configured into a plurality of overlapped or non-overlapped sub-BWPs, the UE may receive a PDCCH and/or a PDSCH and/or a reference signal from one sub-BWP for one BWP at a time (a specific time) through the plurality of sub-BWPs in the active DL BWP based on a specific frequency hopping pattern and may transmit a PUCCH and/or a PUSCH and/or a sounding reference signal (SRS) through one sub-BWP for one BWP at a time (a specific time) through the plurality of sub-BWPs in the active UL BWP based on the specific frequency hopping pattern. The UE in RRC_IDLE or RRC_INACTIVE state may select a sub-BWP (or an initial active sub-BWP) based on the frequency hopping pattern from an initial DL BWP, may receive paging, system information, or RACH MSG2/MSG4/MSGB, and may transmit RACH MSG1/MSGA/MSG3 by selecting a sub-BWP (or an initial active sub-BWP) based on the frequency hopping pattern from an initial UL BWP.

In a method based on the frequency hopping pattern, the frequency hopping pattern may include one or more of the following options.
> The BS may transfer configuration information about one or more hopping patterns and an ID for each of the plurality of hopping patterns through an RRC message, and may transfer indication information indicating the ID of the hopping pattern to be applied through an RRC message (MAC CE or DCI). The UE may receive the configuration information, and when an ID is indicated through the indication information, the UE may perform the following operation.
When frequency hopping is not currently applied/executed, the UE may transmit and receive a signal based on the frequency hopping pattern of the indicated ID.
When frequency hopping is currently applied/executed, the UE may change the frequency hopping pattern of the indicated ID to a frequency hopping pattern and perform signal transmission/reception.
The transmission and reception operation of the signal may be performed based on the frequency hopping pattern according to the ID after a certain time immediately after receiving the ID. Here, the certain time may be designated/determined based on the UE capability or indicated/determined through an RRC configuration of the BS.
> The BS and the UE may configure a pattern for frequency hopping a frequency period of 5 MHz or a frequency bandwidth of 5 MHz, which is a sub-BWP, based on a symbol index, a slot index, a subframe index, and/or an SFN index, as follows.
The BS may connect/map at least one BWP (and/or at least one sub-BWP) with a specific symbol index, a specific slot index, a specific subframe index, and/or a specific SFN index in the hopping pattern. Alternatively, the BS may connect/map a specific BWP and/or a specific sub-BWP to at least one symbol index, at least one slot index, at least one subframe index, and/or at least one SFN index. As such, by connecting different BWPs (and/or different sub-BWPs) for each symbol index, slot index, subframe index, and/or SFN index (in this pattern), the BS may configure a frequency hopping pattern for frequency hopping between BWPs (and/or sub-BWPs) over time. When the frequency hopping pattern is configured as such, the UE may be allocated a PDSCH or PUSCH resource scheduled by the DCI according to a sub-BWP connected to a specific symbol index, a specific slot index, a specific subframe index, and/or a specific SFN index based on the configured frequency hopping pattern.
For example, when the UE receives DCI in a first slot of a first subframe, the UE may transmit a PUSCH (or receive a PDSCH) scheduled by the DCI in a first sub-BWP of the first BWP. Alternatively, when the UE receives the DCI in a second slot of the first subframe, the UE may transmit the PUSCH scheduled by the DCI (or receive the PDSCH) in a second sub-BWP of the first or second BWP. In this case, the UE may transmit a PSUCH or receive a PDSCH based on the frequency hopping pattern. Through this, a phenomenon of resources being concentrated on the specific frequency or a specific sub-BWP (or a phenomenon of resources being concentrated and allocated) may be resolved.

When the frequency hopping pattern is configured, the UE may transmit and receive a signal as follows.
When DCI received in a first slot indicates that a PDSCH is transmitted in a second slot, the UE may determine a BWP and/or sub-BWP for a second slot according to a configured frequency hopping pattern, and determine a PDSCH resource in the determined sub-BWP of the determined BWP to receive the PDSCH. Here, the first slot and the second slot may be the same or different.
When the DCI received in the first slot indicates transmission of a PUSCH in the second slot, the UE may determine a BWP and/or sub-BWP for the second slot according to the configured frequency hopping pattern, and transmit the PUSCH based on the PUSCH resources allocated in the determined sub-BWP of the determined BWP. Here, the first slot and the second slot may be the same or different.
When a specific semi-persistent scheduling (SPS) is activated, the UE may determine a BWP and/or sub-BWP for a slot to which the corresponding SPS PDSCH is allocated according to a configured frequency hopping pattern, and receive the SPS PDSCH in an SPS PDSCH resource allocated in the determined sub-BWP of the determined BWP.
When a specific CG is activated, the UE may determine a BWP and/or sub-BWP for a slot to which a corresponding CG PUSCH is allocated according to a configured frequency hopping pattern, and transmit the CG PUSCH based on the CG PUSCH resources allocated to the determined sub-BWP of the determined BWP.

### R—SIB1 Reception of Rel.18 R-UE

The Rel. 18 R-UE receives the Rel. 18 PDSCH transmitting system information according to the methods 1, 2, and 3. In this case, the DCI of methods 1, 2, and 3 is DCI of which CRC is scrambled with SI-RNTI.

When Rel.18 PDSCH transmits R—SIB1 for Rel. 18 R-UE, the DCI may schedule Rel.18 PDSCH for R—SIB1 as follows.
(1) Opt 1: One DCI on CORESET shared by pre-Rel. 18 UE and Rel. 18 UE schedules pre-Rel.18 SIB1 as well as Rel. 18 R—SIB1 in FDM within an initial DL BWP of 20 MHz.
(2) Opt 2: One DCI on the CORESET shared by pre-Rel.18 UE and Rel. 18 UE schedules pre-Rel.18 SIB1 within the initial DL BWP of 20 MHz as well as Rel.18 R—SIB1 outside the initial DL BWP of 20 MHz via FDM.
(3) Opt 3: One DCI on CORESET shared by pre-Rel. 18 UE and Rel. 18 UE schedules pre-Rel.18 SIB1 as well as Rel.18 R—SIB1 in FDM within an initial DL BWP of 20 MHz. In Opt3, Rel.18 PDSCH transferring Rel. 18 R—SIB1 is scheduled within (sub) BWP of 5 MHz or BW position, and in contrast, a legacy PDSCH transferring pre-Rel. 18 SIB1 is scheduled within an initial BWP of 5 MHz or an initial BWP of 20 MHz.

The BS may indicate via the DCI or MIB whether the DCI schedules both Rel. 18 R—SIB1 and pre-Rel. 18 SIB1, such as the Opt.

When a Rel. 18 R-UE receives an existing SIB1 or a DCI scheduling the existing SIB1, the Rel. 18 R-UE receives a separate cellBarred parameter for the Rel. 18 R-UE from the existing SIB1 or from the DCI scheduling the existing SIB1. Based on the received cellBarred parameter, the Rel.18 R-UE determines whether the UE is capable of accessing a cell or whether the cell needs to be barred.

When the Rel. 18 R-UE does not receive the existing SIB1 and receives a new R—SIB1 or a DCI scheduling an R—SIB1, the UE selects a sub-BWP for the R—SIB1 and receives a separate cellBarred parameter for the Rel. 18 R-UE from the DCI of the selected sub-BWP or the R—SIB1. Based on the received cellBarred parameter, the Rel. 18 R-UE determines whether the UE is capable of accessing a cell or whether the cell needs to be barred.

When on-demand SI is configured, the BS may configure dedicated RACH resources for on-demand SI requests. Alternatively, a dedicated RACH resource may be configured for UE identification during initial access. For the on-demand SI request or the UE identification during initial access, the BS may separately allocate RACH resources for Rel. 17 R—UEs, RACH resources for Rel. 18 R—UEs, and RACH resources for a normal UE. The BS may separately allocate a RACH resource for an option BW1 UE, a RACH resource for an option BW2 UE, and a RACH resource for an option BW3 UE for an Rel. 18 R-UE. These different RACH resources may be separately allocated through the existing SIB1 and R—SIB1. In this case, the Rel. 18 R-UE selects a PRACH resource that matches a UE type thereof and transmits MSG1 or MSGA. It may be possible to indicate an Rel. 18 R-UE through the (sub-) header of the MAC PDU of MSG3 PUSCH or MSGA PUSCH, or to indicate an Option BW1 or BW2 or BW3 depending on a UE type.

### Paging Reception of Rel.18 R-UE

The Rel. 18 R-UE receives the Rel. 18 PDSCH transmitting a paging message according to the methods 1, 2, and 3. In this case, the DCI of methods 1, 2, and 3 is DCI of which CRC is scrambled with P-RNTI.

In the methods 1, 2, and 3, instead of the DCI, the DCI for paging early indication (PEI) may indicate a (sub-) BWP or BW location for the R-UE for Rel. 18 paging PDSCH reception. Alternatively, in the methods 1, 2, and 3, instead of the DCI, the DCI for PEI may provide frequency domain resource allocation (FDRA) and/or time domain resource allocation (TDRA) information for Rel.18 paging PDSCH reception.

When the tracking reference signal (TRS) for paging is configured for Rel.18 R-UE, the Rel. 18 TRS may be configured as follows.
(1) Opt 1: The TRS for paging of Rel.18 R-UE is configured only within the initial BWP or sub-BWP or BW location of 5 MHz for Rel. 18 R-UE.

When a TRS for a Rel. 18 R-UE performs frequency hopping, the TRS performs frequency hopping only within the initial BWP or sub-BWP or BW location of 5 MHz for the Rel.18 R-UE.
(2) Opt 2: The TRS for paging of Rel.18 R-UE is also configured outside the initial BWP or sub-BWP or BW location of 5 MHz for Rel.18 R-UE. In this case, the TRS is configured within the initial BWP for Rel. 17 R-UE at 20 MHz.

The Rel. 18 R-UE (especially UE with option BW1 or 2) receive TRS through RF re-tuning.

FIG. 10 is a diagram for explaining a method for a UE to transmit a message related to a RACH procedure to a cell or BS.

Referring to FIG. 10, the UE may receive at least one synchronization signal block (SSB) and trigger a random access channel (RACH) procedure for a selected cell based on the at least one SSB (S101). For example, the UE may trigger a RACH procedure for a selected cell based on the at least one SSB for initial access, handover, secondary cell (SCell) addition, or SCell activation as described above.

Then, the UE may determine an initial bandwidth for performing the RACH procedure in an uplink bandwidth part (UL BWP) configured for the selected cell/BS (S103). Here, the UL BWP may be an initial UL BWP configured in relation to the RACH procedure. In detail, when at least one bandwidth having a size of a first frequency bandwidth (or a first size, 5 MHz) is configured for the UL BWP, the UE may determine an initial bandwidth (or a first UL active sub-BWP) for performing a RACH procedure from among the at least one bandwidth (or at least one UL sub-BWP) based on the at least one SSB. For example, the UE may receive at least one SSB and measure the quality of the SSB for each of the at least one received SSB. The UE may determine a specific SSB having a quality higher than or equal to a specific threshold from among the at least one SSB based on the measured quality of the SSB and may determine a bandwidth corresponding to the determined specific SSB from among the at least one bandwidth as the initial bandwidth (or, first UL active sub-BWP). Here, each of the at least one bandwidth may have a corresponding SSB index preconfigured. For example, a plurality of bandwidths having a size of a first frequency bandwidth may be configured for the UL BWP, and an index of a corresponding SSB may be preconfigured/mapped to each of the plurality of bandwidths. For example, for each of the plurality of bandwidths, a mapping relationship for the index of the corresponding SSB may be previously indicated/configured through SIB1, and the like. Here, the at least one bandwidth may be defined as a (UL) Sub-BWP having a size of 5 MHz or less as described above. In this case, the UL BWP may determine/select one sub-BWP from among at least one sub-BWP as the initial sub-BWP, which is the initial bandwidth. Here, one or more bandwidths less than or equal to the first size may be configured within the UL BWP according to the “method of configuring one or more sub-BWPs” described above.

Alternatively, when there are two or more SSBs from among the received plurality of SSBs having qualities higher than or equal to a specific threshold, the UE may identify an index of an SSB having the highest quality from among the two or more SSBs, and configure/determine a bandwidth corresponding to the index of the identified SSB from among the at least one bandwidth as the initial bandwidth (or, first UL active sub-BWP). Alternatively, the UE may randomly select one SSB from among the two or more SSBs, and configure/determine a bandwidth corresponding to an index of the selected one SSB from among the at least one bandwidth as the initial bandwidth. Alternatively, the UE may select one SSB from among the two or more SSBs based on an identifier (UE ID) of the UE, and configure/determine a bandwidth corresponding to an index of the selected one SSB from among the at least one bandwidth as the initial bandwidth. For example, the UE may select one SSB from among the two or more SSBs based on the result of a modulo operation (UE ID mod M) on the number of bandwidths equal to or less than the first size configured in the UE ID and the UL BWP.

Alternatively, the UE may obtain information on the SSB index for the at least one SSB and information on the specific threshold from SIB1 (System Information Block 1) received from a BS or a cell. The specific threshold may be configured for each SSB index or one threshold value may be configured in relation to the initial bandwidth determination. When the specific threshold is configured for each SSB index, different specific thresholds may be configured for each SSB index. Here, the UE may receive the SIB1 based on a frequency bandwidth having a size of 5 MHz or less as described in “R—SIB1 reception of Rel. 18 R-UE”. Alternatively, the UE may receive TRS, and the like for paging in a bandwidth of 1 size or 5 MHz or less as configured in “Rel. 18 R-UE Paging Reception”.

Then, the UE may transmit a message (MSGA) including a physical random access channel (PRACH) or PRACH preamble related to the RACH procedure or the PRACH and a physical uplink shared channel (PUSCH) to the cell or BS in the determined initial bandwidth (or, first UL active sub-BWP). For example, as described with reference to FIG. 6, the UE may transmit Msg1 and/or Msg3 in the initial bandwidth when based on a 4-step RACH procedure, and may transmit MsgA (including PRACH and PUSCH) in the initial bandwidth (or, first UL active sub-BWP) when based on a 2-step RACH procedure.

The UE may receive Msg2 or MsgB responding to a message (MSGA) including the PRACH and physical uplink shared channel (PUSCH) from the BS or cell. Here, the UE may determine an initial bandwidth (or, first DL active sub-BWP) within the DL BWP similarly to the method of determining an initial bandwidth (or, first UL active sub-BWP) within the UL BWP, and may receive the Msg2 or MsgB within the determined DL initial bandwidth. For example, the UE may determine one bandwidth from among a plurality of bandwidths configured in the DL BWP (i.e., a plurality of DL Sub-BWPs) based on the quality of the SSB as the DL initial bandwidth, and receive the Msg2 or MsgB within the DL initial bandwidth.

Alternatively, the UE may frequency hop the initial bandwidth or sub-BWP based on the slot/symbol/SFN/sub-frame index as described in “Frequency hopping method of BWP and Sub-BWP” after initial access. In this case, the UE may receive a DL signal or transmit a UL signal in a hopped sub-BWP according to frequency hopping.

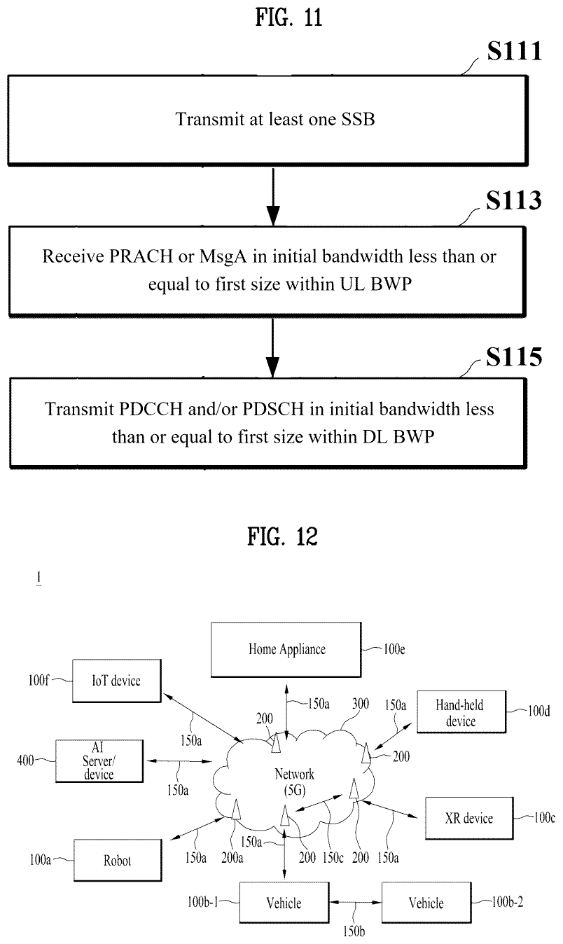

FIG. 11 is a diagram for explaining a method for a BS to receive a message related to a RACH procedure from a UE.

Referring to FIG. 11, the BS (or cell) may transmit at least one synchronization signal block (SSB) (S111). A random access channel (RACH) procedure for a selected cell may be triggered based on at least one SSB. For example, the UE may trigger a RACH procedure for a selected cell based on the at least one SSB for initial access, handover, secondary cell (SCell) addition, or SCell activation as described above.

Then, the BS may receive a message (MSGA) including a physical random access channel (PRACH) or PRACH preamble related to a RACH procedure or the PRACH and a physical uplink shared channel (PUSCH) in an initial bandwidth less than or equal to a first size (e.g., 5 MHz) within the UL BWP (S113). For example, as described with reference to FIG. 6, the BS may receive Msg1 and/or Msg3 in the initial bandwidth when based on a 4-step RACH procedure, and may receive MsgA (including PRACH and PUSCH) in the initial bandwidth when based on a 2-step RACH procedure. In detail, as described in the “method of configuring one or more sub-BWPs” described above, the UL BWP may be configured to one or more bandwidths less than or equal to the first size (or limited to or less than the first size) or one or more UL Sub-BWPs. In this case, the BS may receive the Msg1, MsgA and/or Msg3 in a UL initial bandwidth that is one or more bandwidths less than or equal to the first size or one or more UL Sub-BWPs. The UL initial bandwidth may be determined from among one or more bandwidths less than or equal to the first size or one or more UL Sub-BWPs based on the quality of at least one SSB as described in FIGS. 8 to 10.

The BS may transmit to the UE a system information block 1 (SIB1) including information on an SSB index for at least one SSB and information on a specific threshold. Here, the specific threshold may be configured for each SSB index or one threshold value may be configured in relation to the initial bandwidth determination. When the specific threshold is configured for each SSB index, different specific thresholds may be configured for each SSB index. Here, the BS may transmit the SIB1 based on a frequency bandwidth having a size of 5 MHz or less as described in “R—SIB1 reception of Rel.18 R-UE”. Alternatively, the BS may transmit TRS, and the like for paging in a bandwidth of 1 size or 5 MHz or less as configured in “Rel. 18 R-UE Paging Reception”.

Then, the BS may transmit Msg2 or MsgB (or PDSCH and/or PDSCH) responding to a message (MSGA) including the PRACH and a physical uplink shared channel (PUSCH) to the UE (S115). Here, the BS may determine the initial bandwidth (i.e., DL initial bandwidth) within the DL BWP similarly to the method of determining the initial bandwidth (i.e., UL initial bandwidth) within the UL BWP. For example, the BS may determine an index of a corresponding SSB based on an initial bandwidth in which a PRACH or MsgA is received, and may determine one bandwidth from among a plurality of bandwidths configured in the DL BWP (i.e., a plurality of DL Sub-BWPs) corresponding to the determined index of the SSB as the DL initial bandwidth. In this case, the BS may transmit the Msg2 or MsgB within the determined DL initial bandwidth. That is, the BS may estimate an index of an SSB received from the UE with a quality higher than or equal to a certain threshold or an index of an SSB corresponding to the initial bandwidth based on the initial bandwidth (or, UL initial sub-BWP) in which the PRACH or MsgA is received, and determine the DL initial bandwidth based on the index of the estimated SSB.

Alternatively, the BS may transmit a DL signal to the UE or receive a UL signal from the UE in a frequency hopped initial bandwidth or sub-BWP based on the slot/symbol/SFN/sub-frame index as described in “Frequency hopping scheme of BWP and sub-BWP” after the RACH procedure is completed.

As such, the proposed disclosure may explicitly determine/specify an initial frequency band of 5 MHz for transmitting a signal related to a RACH procedure within a UL BWP based on the quality of an SSB. Alternatively, the proposed disclosure may explicitly determine/specify an initial frequency band of 5 MHz for receiving a signal related to a RACH procedure within a UL BWP based on the quality of an SSB. Even if an initial frequency band is limited to 5 MHz, the initial frequency band may be effectively distributed from among the UEs by determining the initial frequency band based on the quality of the SSB. That is, it may be possible to effectively prevent UEs transmitting a PRACH from being concentrated on a single limited initial frequency band of 5 MHz.

FIG. 12 illustrates a communication system 1 applied to the present disclosure.

Referring to FIG. 12, a communication system 1 includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an extended Reality (XR) device 100c, a hand-held device 100d, a home appliance 100e, an Internet of Things (IoT) device 100f, and an Artificial Intelligence (AI) device/server 400. For example, the vehicles may include a vehicle having a wireless communication function, an autonomous driving vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as uplink/downlink communication 150a, sidelink communication 150b (or, D2D communication), or inter BS communication (e.g. relay, Integrated Access Backhaul (IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

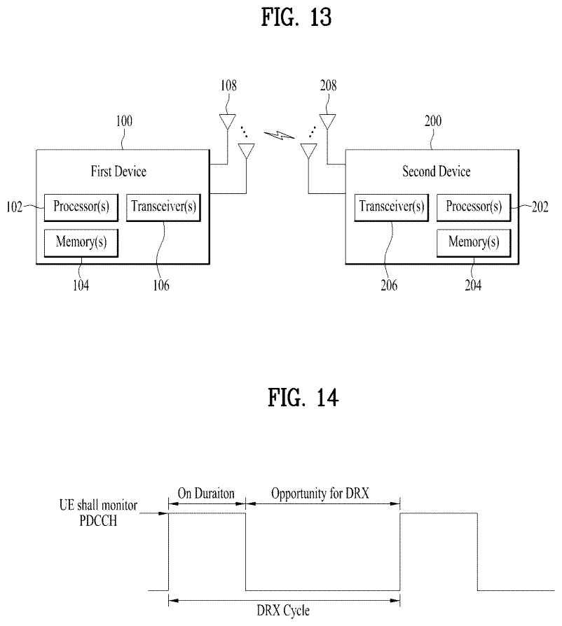

FIG. 13 illustrates wireless devices applicable to the present disclosure.

Referring to FIG. 13, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. 12.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In the present disclosure, the wireless device may represent a communication modem/circuit/chip.

According to an example, the first wireless device 100 or UE may include a processor 102 and a memory 104 connected to the RF transceiver. The memory 104 may include at least one program for performing an operation related to the embodiments described in FIGS. 9 to 11.

In detail, the processor 102 may control the RF transceiver 106 to trigger a random access channel (RACH) procedure for a selected cell based on at least one synchronization signal block (SSB) received from a cell, determine an initial bandwidth within an uplink bandwidth part (UL BWP) of the cell, and transmit a physical random access channel (PRACH) or a first message including the PRACH in an initial bandwidth, wherein the initial bandwidth may be determined as one of one or more bandwidths less than or equal to a first size configured for the UL BWP of the cell, based on an index of an SSB having a quality greater than or equal to a specific threshold from among the at least one SSB.

Alternatively, a processing device that controls a UE performing communication with a BS may include the processor 102 and the memory 104. In this case, the processing device may include at least one processor; and at least one memory connected to the at least one processor and storing instructions, the instructions being executed by the at least one processor to cause the UE to trigger a random access channel (RACH) procedure for a selected cell based on at least one synchronization signal block (SSB), determine an initial bandwidth within an uplink bandwidth part (UL BWP) of the cell, and transmit a physical random access channel (PRACH) or a first message including the PRACH in an initial bandwidth, wherein the initial bandwidth may be determined as one of one or more bandwidths less than or equal to a first size configured for the UL BWP of the cell, based on an index of an SSB having a quality greater than or equal to a specific threshold from among the at least one SSB.

Alternatively, a non-transitory computer-readable storage medium having recorded thereon instructions for performing the proposed methods described with reference to FIGS. 9 to 11 may be configured.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the wireless device may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more Service Data Unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

FIG. 14 is a diagram for explaining a DRX (Discontinuous Reception) operation of a UE according to one embodiment.

The UE can perform DRX operation while performing the procedures and/or methods described/suggested above. The UE with DRX configured can reduce power consumption by discontinuously receiving DL signals. DRX can be performed in the RRC (Radio Resource Control)_IDLE state, the RRC_INACTIVE state, and the RRC_CONNECTED state. In the RRC_IDLE state and the RRC_INACTIVE state, DRX is used to discontinuously receive paging signals. Hereinafter, DRX performed in the RRC_CONNECTED state (RRC_CONNECTED DRX) will be described.

A DRX cycle consists of On Duration and Opportunity for DRX. The DRX cycle defines a time interval during which the On Duration is periodically repeated. The On Duration represents a time period during which the UE monitors to receive a PDCCH. When DRX is configured, the UE performs PDCCH monitoring during the On Duration. If a PDCCH is successfully detected during the PDCCH monitoring, the UE operates an inactivity timer and remains in an awake state. On the other hand, if no PDCCH is successfully detected during the PDCCH monitoring, the UE enters a sleep state after the On Duration ends. Therefore, when DRX is configured, PDCCH monitoring/reception may be performed discontinuously in the time domain when performing the procedures and/or methods described/proposed above. For example, when DRX is configured, a PDCCH reception opportunity (e.g., a slot having a PDCCH search space) in the present disclosure may be configured discontinuously according to the DRX configuration. On the other hand, when DRX is not configured, PDCCH monitoring/reception may be performed continuously in the time domain while performing the procedure and/or method described/proposed above. For example, when DRX is not configured, PDCCH reception opportunities (e.g., slots having PDCCH search spaces) in the present disclosure may be configured continuously. Meanwhile, PDCCH monitoring may be restricted in a time interval configured as a measurement gap, regardless of whether DRX is configured.

The above-described embodiments are combinations of elements and features of the present disclosure in specific forms. The elements or features may be considered selective unless mentioned otherwise. Each element or feature may be implemented without being combined with other elements or features. Further, the embodiments of the present disclosure may be configured by combining some elements and/or some features. Operation orders described in the embodiments of the present disclosure may be rearranged. Some constructions or features of any one embodiment may be included in another embodiment or may be replaced with corresponding constructions or features of another embodiment. It is obvious that claims that are not explicitly cited in the appended claims may be presented in combination as an embodiment of the present disclosure or included as a new claim by subsequent amendment after the application is filed.

Those skilled in the art will appreciate that the present disclosure may be carried out in other specific ways than those set forth herein without departing from the spirit and essential characteristics of the present disclosure. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

### INDUSTRIAL APPLICABILITY

The present disclosure can be used in a UE, a base station, or other equipment of a wireless mobile communication system.

1. A method by a user equipment (UE) comprising:
triggering a random access channel (RACH) procedure for a selected cell based on at least one synchronization signal block (SSB);
determining an initial bandwidth within an uplink bandwidth part (UL BWP) of the cell; and
transmitting a physical random access channel (PRACH) or a first message including the PRACH in the initial bandwidth,
wherein, based on an index of an SSB having a quality higher than or equal to a specific threshold from among the at least one SSB, the initial bandwidth is determined as one of one or more bandwidths less than or equal to a first size configured for a UL BWP of the cell.

2. The method of claim 1, wherein the index of the SSB is an index for an SSB having a highest quality from among SSBs having a quality higher than or equal to the specific threshold from among the at least one SSB.

3. The method of claim 1, wherein, based on that there are two or more SSBs having a quality higher than or equal to a specific threshold from among the at least one SSB, the index of the SSB is an index for one SSB randomly selected from among the two or more SSBs.

4. The method of claim 1, wherein the UL BWP of the cell is configured with a plurality of sub-BWPs having a frequency bandwidth size less than or equal to the first size, and
the initial bandwidth is one sub-BWP determined based on an index of an SSB having a quality higher than or equal to the specific threshold of the at least one SSB from among the plurality of sub-BWPs.

5. The method of claim 1, further comprising receiving a system information block 1 (SIB1) including SSB indices and information about the specific threshold,
wherein each of one or more bandwidths less than or equal to the first size is pre-mapped with each of the SSB indices.

6. The method of claim 1, further comprising transmitting a message including a physical uplink shared channel (PUSCH) for the RACH procedure in the initial bandwidth.

7. The method of claim 1, wherein the RACH procedure is triggered for initial access, handover, secondary cell (SCell) addition, or SCell activation.

8. The method of claim 1, wherein the first size is 5 MHz.

9-11. (canceled)

12. A user equipment (UE) comprising:
a radio frequency (RF) transceiver; and
a processor connected to the RF transceiver,
wherein the processor is configured to control the RF transceiver to trigger a random access channel (RACH) procedure for a selected cell based on at least one synchronization signal block (SSB) received from a cell, determine an initial bandwidth within an uplink bandwidth part (UL BWP) of the cell, and transmit a physical random access channel (PRACH) or a first message including the PRACH in the initial bandwidth, and
wherein, based on an index of an SSB having a quality higher than or equal to a specific threshold from among the at least one SSB, the initial bandwidth is determined as one of one or more bandwidths less than or equal to a first size configured for a UL BWP of the cell.

13. A method by a base station (BS) comprising:
transmitting at least one synchronization signal block (SSB); and
receiving a physical random access channel (PRACH) or a first message including the PRACH in an initial bandwidth less than or equal to a first size,
wherein the initial bandwidth is one bandwidth corresponding to an index of a specific SSB from among a plurality of bandwidths less than or equal to the first size configured for an uplink bandwidth part (UL BWP) related to the BS, and
wherein the index of the specific SSB is an index of an SSB having a quality higher than or equal to a specific threshold from among the at least one SSB.

14. (canceled)
